(19) United States
(12) Patent Application Publication
(10) Pub. No.: US 2007/0291131 A1
(43) Pub. Date: Dec. 20, 2007

(54) Apparatus and Method for Controlling Image Coding Mode

(76) Inventors: Mitsuru Suzuki, Gifu (JP); Shigeyuki Okada, Gifu (JP); Shinichiro Okada, Aichi (JP)

Correspondence Address: MCDERMOTT WILL & EMERY LLP, 600 13TH STREET, N.W., WASHINGTON, DC, 20005-3096, US

(21) Appl. No.: 10/588,791

(22) PCT Filed: Jan. 27, 2005
(86) PCT No.: PCT/JP05/01137

§ 371 Date: May 7, 2007

(30) Foreign Application Priority Data
Feb. 9, 2004 (JP) 2004-032366
Feb. 23, 2004 (JP) 2004-046399
Feb. 23, 2004 (JP) 2004-046400
Mar. 31, 2004 (JP) 2004-103678
Dec. 21, 2004 (JP) 2004-369604

(51) Int. Cl. H04N 7/32

(52) U.S. Cl. 348/222.1; 375/240.13; 348/905

(57) ABSTRACT

As result of the diversified structure of a terminal device, the demand for data format is also diversified and there is a need to adjust a terminal to such a demand. An image coding apparatus according to the present invention uses a method complied with MPEG, as a method by which to code images, and particularly uses intra-frame coding and inter-frame coding. As an inter-frame coding method, a first mode which is a reference mode using bidirectional coding and a second mode which is a reference mode not using the bidirectional coding can be selectively set. In the case of the first mode, the bidirectional coding is not used, so that B pictures are not generated and the images are coded with I pictures and P pictures only.

### RELATED APPLICATIONS

This application is the U.S. National Phase under 35 U.S.C. § 371 of International Application No. PCT/JP2005/001137, filed on Jan. 27, 2005, which in turn claims the benefit of Japanese Application No. JP 2004-032366 filed on Feb. 2, 2004, Japanese Application No. JP 2004-046399 filed on Feb. 23, 2004, Japanese Application No. JP 2004-046400 filed on Feb. 23, 2004, Japanese Application No. JP 2004-103678 filed on Mar. 31, 2004, and Japanese Application No. JP 2004-369604 filed on Dec. 21, 2004, the disclosures of which Applications are incorporated by reference herein.

### TECHNICAL FIELD

The present invention relates to an image coding apparatus and an image pickup apparatus and it particularly relates to a technique for controlling a coding method. The present invention relates also to the image compression technique and it particularly relates to an image coding apparatus that codes the moving images by an image coding scheme including an inter-frame bidirectional predictive mode and a method therefor.

### BACKGROUND TECHNOLOGY

In recent years, the image processing technique or integrated technology for circuits have been improved and a broad range of communication means such as broadband communication and wireless LAN communication in the communication technology has been spread widely, so that various terminals or equipment are equipped normally with a function for handling the multimedia. For example, many mobile phones are provided, for granted, with the Internet function, still/moving image shooting function, and soon or later the television-phone function or various broadcast receiving function will be the de facto standard. In the case of a digital camera, it is not uncommon that the moving pictures can be recorded and reproduced with the image quality almost as good as with the video camera, and music reproduction capability and communication capability are further getting provided. In this manner, aside from the intrinsic function that each information terminal has, the functions which have been realized in other terminals are installed and the versatility of terminal devices is ever growing.

Here, one of main contents treated in each information terminal is the moving pictures. The coding technology is indispensable in dealing with the moving pictures. The technology considered to play the central role thereof is MPEG (Moving Picture Expert Group) method. As a coding technique in MPEG, the intra-frame coding and the inter-frame coding are mainly used. As the inter-frame coding, there are a forward reference in which the pictures in the past are referred to for the purpose of coding a picture at a certain instant and a bidirectional reference in which the pictures both in the past and the future are referred to for the purpose of coding a picture at a certain instant. A picture which has been subjected to the intra-frame coding is called an I picture (Intra-Picture), one subjected to the forward reference is called a P picture (Predictive-Picture), and one subjected to the bidirectional reference is called a B-picture (Bidirectionally-predictive-Picture).

[Patent Reference (1)]

Japanese Patent Application Laid-Open No. Hei 08-154250.

As described above, as a result of versatility in the terminal devices, their hardware structures and software configurations are also diversified. Thus, various constraints according to their execution environments in coding the moving pictures are imposed on each information terminal. It is indispensable to relieve such constraints in the course of further promoting the diversity of the information terminals.

### DISCLOSURE OF THE INVENTION

The present invention has been made under the above-mentioned background and an object of the present invention is to provide equipment capable of performing a coding by a suitable method according to an execution environment for the coding.

In order to solve the above problems, an image coding apparatus according to one embodiment of the present invention comprises: a coding circuit which codes an image signal to be coded, by using at least one of intra-frame coding scheme and inter-frame coding scheme; and a reference mode selection circuit which sets selectively either a reference mode that uses a bidirectional coding in which a past frame and a future frame are referred to or a reference mode that does not use the bidirectional coding, as the inter-frame coding scheme, according to an coding execution environment in the apparatus.

The “coding execution environment in the apparatus” includes, for example, various parameters such as the setting of resolution related to the images to be captured, the setting of picture quality, an image shooting mode and a frame rate, and information indicating a free space of recording medium, a type of recording medium, a processing capacity at an image forwarding destination, a degree of congestion in data transmission channel, a mode coping with a special reproduction, power consumption and a remaining battery level. For example, the forward coding is also available as the inter-frame coding scheme other than the above-mentioned bidirectional coding. Compared with the bidirectional reference, the forward coding has a property of being high in data compression ratio but high in processing load.

According to this embodiment, selecting a reference mode having a property suitable for an environment in question in response to various environments in which the coding processing is carried out can achieve the optimum coding processing.

Another embodiment of the present invention relates to an image pickup apparatus. This apparatus comprises: an image input unit which takes an image of an object and acquires an image signal; a coding circuit which codes the acquired image signal by using at least one of intra-frame coding scheme and inter-frame coding scheme; a reference mode selection circuit which sets selectively either a reference mode that uses a bidirectional coding in which a past frame and a future frame are referred to or a reference mode that does not use the bidirectional coding, as an inter-frame compressing and coding in the coding scheme, according to an coding execution environment in the apparatus; and a data storage unit which stores coded data generated by the coding.

According to this embodiment, in an image pickup apparatus such as a digital camera that can take pictures of motion images, a reference mode suitable according to an execution environment when the images taken by the apparatus are coded. This allows to enhance the compression ratio or image quality of a captured image as compared with a case where a single reference mode is used.

Still another embodiment of the present invention relates to an image coding apparatus. This image coding apparatus comprises: a predictive mode selector which outputs information indicating a predictive mode used to code a frame constituting moving images, at the time when the moving images are to be coded; and a coding unit which codes the frame based on the information, indicating the predictive mode, outputted from the predictive mode selector, wherein when the moving images are coded using a predictive mode containing an inter-frame bidirectional predictive mode, the predictive mode selector outputs information indicating that global motion compensation is used, as information indicating a predictive mode used to code a future reference frame of a frame which is coded in the inter-frame bidirectional predictive mode. Here, the “frame” indicates an individual image that constitutes the moving images and may be rephrased as “picture”, “plane” or the like.

When the information indicating that global motion compensation is used is outputted from the predictive mode selector, the coding unit may code a part whose motion vector is a zero vector in the inter-frame predictive mode, using a global motion vector. When the information indicating that global motion compensation is used is outputted from the predictive mode selector, the coding unit may code a part whose motion vector is a zero vector in the forward inter-frame predictive mode and whose difference data from a reference frame is practically zero, using the global motion compensation. When a future reference frame of a frame which is coded in the inter-frame bidirectional mode is coded prior to coding the frame and also there exists a macroblock whose motion vector is a zero vector, the motion vector may be treated as a global motion vector. When there exists a macroblock in which the motion vector is a zero vector and data difference relative to a past reference frame is practically zero and also in which the coding is performed using a “not_coded” flag, the macroblock may be coded using global motion compensation. This allows to provide with difference data relative to a reference image, instead of using a copy of the past reference frame, at the time of coding a frame in the inter-frame bidirectional predictive mode. Thereby, the loss of image can be prevented and the image quality of decoded images can be enhanced. Here, that the difference data are practically zero means that the differences between frames to be coded and reference frames are all zeroes or the difference is sufficiently small so that it can be regarded as zero. For example it may include a case where the difference data after quantization are all zeroes or a case where the difference data are smaller than a prescribed threshold value. The prescribed threshold value may be determined according to the size or image quality of an image or macroblock. For example, the number of pixels×1(2, 3, . . . ) may serve as the threshold value.

The predictive mode selector may acquire a profile used for coding the moving images, and may determine whether the inter-frame bidirectional predictive mode is contained or not, by referring to the profile.

When the future reference frame of a frame which is coded in the inter-frame bidirectional predictive mode is a P frame, the predictive mode selector may output information indicating that the frame is coded as an S frame including a global motion vector, instead of the P frame, as information indicating a predictive mode used to code the frame. Here, “P frames” may be “P pictures” in MPEG-2 or “P-VOPs” in MPEG-4. “S frames” may be “S-VOPs” in MPEG-4. When the coding is performed on a P frame, the predictive mode selection unit may determine whether the P frame is referred to from a B frame in a backward direction or not; and if it is determined that the P frame is referred to from the B frame in a backward direction, the P-frame may be switched to S-frame beforehand. Thereby, the problem of a missing image can be resolved without causing a problem of the increase in computational amount and the reduction in processing speed.

For all frames which should have been coded as P frames, the predictive mode selector may output information indicating that the frame is coded as an S frame including a global motion vector, instead of the P frame, as information indicating a predictive mode used to code the frame. In a case of a profile containing a B-frame, the predictive mode selector may switch a P-frame to an S-frame beforehand. Thereby, the problem of a missing image can be resolved without causing a problem of the increase in computational amount and the reduction in processing speed.

Still another embodiment of the present invention relates to an image coding method. This method comprises: outputting information indicating a predictive mode used to code a frame constituting moving images, at the time when the moving images are to be coded; and coding the frame based on the information indicating the predictive mode, wherein when the moving images are coded using a predictive mode containing an inter-frame bidirectional predictive mode, the outputting outputs information indicating that global motion compensation is used, as information indicating a predictive mode used to code a future reference frame of a frame which is coded in the inter-frame bidirectional predictive mode.

Still another embodiment of the present invention relates to an image coding apparatus. This image coding apparatus is such that, at the time of coding moving images, coding is performed, per frame that constitutes the moving image, based on any mode among an intra-frame coding mode, an inter-frame unidirectional predictive coding mode and an inter-frame bidirectional predictive coding mode, so as to generate a coded data sequence of the moving images, and the apparatus is characterized in that: when the moving images are coded using a predictive mode containing the inter-frame unidirectional predictive coding mode and the inter-frame bidirectional predictive coding mode, and it is determined that, in a frame coded in the inter-frame unidirectional predictive coding mode, a certain block constituting said frame is practically the same as a block, placed at the same position as the certain block, which lies in a reference frame on which a prediction is based, the coding is performed in a manner that information on a motion vector with the reference frame, instead of a flag indicating the determination, is appended into a coded data sequence of the block. Further, when a frame existing between the frame coded in the inter-frame unidirectional predictive coding mode and the reference frame is coded in the inter-frame bidirectional predictive mode, the coding may also be performed on a block at the same position as the block to which the motion vector information has been appended, and a coding parameter may be appended into a coded data sequence.

Here, the “frame” indicates an individual image that constitutes the moving images and contains a concept such as “picture” and “plane”. The “inter-frame unidirectional predictive coding mode” indicates “inter-frame forward predictive coding mode” or “inter-frame backward predictive coding mode”. Also, “practically the same as” means that difference data are zero or sufficiently so small as to be regarded as zero when the difference data between a block of a frame to be coded and a block of a reference frame is obtained per pixel. For example, it may include a case where the difference data after quantization are all zeroes when the difference data undergo quantization processing or a case where the difference data are smaller than a prescribed threshold value.

According to this embodiment, even if there exists a block, in the inter-frame unidirectional predictive coding mode, which can be replaced by reference frame data, the coding will be performed by appending a motion vector instead of a flag, so that the coding parameters can also be added for a block corresponding to a frame coded in the inter-frame bidirectional predictive coding mode. Thereby, decoding can be done completely so as to restore the coding parameters and therefore the loss of image can be prevented and the image quality of decoded images can be enhanced.

The frame coded in the inter-frame unidirectional predictive coding may be a reference frame for the frame coded in the inter-frame bidirectional predictive mode. The code amount of motion vector information is larger when compared with the flag indicative of being practically the same as a block of a reference frame. However, according to this, the motion vector information is appended to at least a reference frame of frames coded in the inter-frame bidirectional predictive coding mode out of frames coded in the inter-frame unidirectional predictive coding mode. Hence, the loss of image which forms a problem when frames coded in the inter-frame bidirectional predictive coding mode are decoded can be prevented and at the same time the increase in code amount can be suppressed.

In this embodiment, the motion vector information may be coded as a zero vector.

Still another embodiment of the present invention relates to an image coding apparatus. This image coding apparatus comprises: a coding mode control unit which outputs information indicating a coding mode used to code a frame, per frame that constitutes moving images, at the time of coding the moving images; and a coding unit which codes the frame, based on the information, indicating a coding mode, outputted from the coding mode control unit, wherein when the coding unit codes a future reference frame of a frame coded in an inter-frame bidirectional predictive mode, it determines, per block that constitutes this frame, whether or not a block is practically the same as a block, placed at the same position as said block, which lies in a reference frame on which a prediction is based, and it counts the number of blocks that have been determined to be practically the same, and wherein when, as information indicating a coding mode used to code a future reference frame of a frame coded in an inter-frame bidirectional predictive mode, the number of blocks that have been determined to be practically the same is greater than or equal to a prescribed threshold value, the coding mode control unit outputs information indicating that the blocks that have been determined to be the same are coded using global motion compensation; and when the number of blocks that have been determined to be practically the same is less than the prescribed threshold value, the coding mode control unit outputs information indicating that the coding is performed, on the blocks that have been determined to be practically the same, by appending information, on a motion vector with the reference frame, to a coded data sequence of said block.

By employing the structure such as this, even if, at the time of coding a targeted frame in the inter-frame bidirectional predictive mode, a future reference frame is a copy of an past reference frame, difference data relative to a reference frame can be provided, for example, instead of being processed automatically as a copy of the past reference frame. Thereby, the loss of image can be prevented and the image quality of decoded images can be enhanced.

When a case where a block determined to be practically the same is coded using the global motion compensation is compared with a case where the coding is performed in a manner that motion vector information relative to the reference frame is appended into a coded data sequence of said block, the former results in a smaller code amount when the number of blocks determined to be practically the same is large whereas the latter results in a smaller code amount when the number of blocks determined to be practically the same is small. According to this embodiment, when the number of blocks determined to be practically the same is greater than or equal to a prescribed threshold value, this block may be coded using the global motion compensation whereas when the number of blocks determined to be practically the same is less than the prescribed threshold value, the coding may be performed in a manner that the motion vector information relative to the reference frame is appended into a coded data sequence of this block. Hence, an effect that the coding efficiency is raised is obtained.

Still another embodiment of the present invention relates to an image coding apparatus. This image coding apparatus is an image coding apparatus which generates a coded data sequence by coding moving images, and the apparatus comprises: a coding unit which codes a frame that constitutes the moving image; a coding method decision unit which determines whether a block in a frame, to be coded, corresponding to a block of a future reference frame is processed as a copy of a prescribed block of a past reference frame when, at the time of coding by the coding unit the frame to be coded in an inter-frame bidirectional predictive mode, a certain block of the future reference frame that the frame to be coded refers to in a backward direction is coded using a flag indicating that the future reference frame is a copy of a prescribed block of a past reference frame that the future reference frame refers to in a forward direction; and an appending unit which appends flag information indicative of a decision result of the coding method decision unit, into the coded data sequence.

By employing the structure such as this, even if, at the time of coding a targeted frame in the inter-frame bidirectional predictive mode, a future reference frame is a copy of a past reference frame, difference data relative to a reference frame can be provided, for example, instead of being processed automatically as a copy of the past reference frame. Thereby, the loss of image can be prevented and the image quality of decoded images can be enhanced.

When the coding method decision unit determines that the block in the frame to be coded shall not be processed as the copy of a prescribed block of a frame of the past reference frame, the coding unit may code difference data between the prescribed block of the past reference frame and the block in the frame to be coded. Thereby, the image of the targeted frame can be obtained by decoding the difference data at a decoding, so that the loss of image can be prevented and the image quality of decoded images can be enhanced.

The coding method decision unit may make a decision based on difference data between the block in the frame to be coded and the prescribed block of the past reference frame. For example, when the data amount of the difference data is larger than a prescribed threshold value, the difference data may be coded so as to be included in a coded data sequence, instead of being processed as a copy of the prescribed block of the past reference frame. Thereby, whether it is processed as a copy or not can be switched according to the data amount of difference data and the like, so that the increase in code amount can be suppressed and at the same time the enhancement of the image quality can be attempted.

The appending unit may append the flag information to the coded data of the frame to be coded or coded data of the block in the frame to be coded. The appending unit may append the flag information to the coded data of the future reference frame or coded data of a block of the future reference frame. The appending unit may append the flag information to a sequence header of the coded data sequence. The position at which the flag information is appended may be adaptively determined according to the code amount, image quality or the like.

Still another embodiment of the present invention relates to an image decoding apparatus. This image decoding apparatus comprises: a decoding unit which acquires and decodes a coded data sequence in which moving images are coded; and a decoding method decision unit which acquires flag information, appended to a prescribed position of the coded data sequence, indicating whether a block of a targeted frame coded in an inter-frame bidirectional predictive mode is processed as a copy of a prescribed block of a past reference frame that the targeted frame refers to in a forward direction or not and which determines a decoding method, wherein when the decoding method decision unit determines that the block of the targeted frame is processed as the copy of the prescribed block of the past reference frame, the decoding unit copies the prescribed block of the past reference frame; and when the decoding method decision unit determines that the block of the targeted frame is not processed as the copy of the prescribed block of the past reference frame, the decoding unit decodes difference data between the block of the targeted frame and the prescribed block of the past reference frame.

By employing the structure such as this, the frames coded in the inter-frame bidirectional predictive mode can be suitably decoded by the above-described image coding apparatus, so that the image quality can be improved.

Still another embodiment of the present invention relates to an image coding method. This image coding method is a method for generating a coded data sequence by coding moving images, and the method comprises: coding a frame that constitutes the moving images; determining whether a block in a frame, to be coded, corresponding to a block of a future reference frame is processed as a copy of a prescribed block of a past reference frame when, at the time of coding by the coding the frame to be coded in an inter-frame bidirectional predictive mode, a certain block of the future reference frame that the frame to be coded refers to in a backward direction is coded using a flag indicating that the future reference frame is a copy of a prescribed block of the past reference frame that the future reference frame refers to in a forward direction; and appending flag information indicative of a decision result, into the coded data sequence.

Still another embodiment of the present invention relates to an image decoding method. This image decoding method comprises: acquiring and decoding a coded data sequence in which moving images are coded; and acquiring flag information, appended to a prescribed position of the coded data sequence, indicating whether a block of a targeted frame coded in an inter-frame bidirectional predictive mode is processed as a copy of a prescribed block of a past reference frame that the targeted frame refers to in a forward direction or not and determining a decoding method, wherein when it is determined in the determining that the block of the targeted frame is processed as the copy of the prescribed block of the past reference frame, the decoding copies the prescribed block of the past reference frame; and when it is determined in the determining that the block of the targeted frame is not processed as the copy of the prescribed block of the past reference frame, the decoding decodes difference data between the block of the targeted frame and the prescribed block of the past reference frame.

Still another embodiment of the present invention relates to a data structure of a coded data sequence. This data structure is a data structure in which moving images have been coded, and it includes flag information indicating whether a block of a first frame coded in an inter-frame bidirectional predictive mode is processed as a copy of a prescribed block of a second frame that the first frame refers to in a forward direction or difference data between the block of the first frame and the prescribed block of the second frame are decoded wherein the flag information is provided at a prescribed position of the coded data sequence.

It is to be noted that any arbitrary combination of the aforementioned constituent elements and the components and expression of the present invention changed mutually among a method, an apparatus, a system, a computer program, a recording medium storing programs and so forth are also effective as the embodiments of the present invention.

### BRIEF DESCRIPTION OF THE DRAWINGS

FIG. 1 schematically shows two kinds of coding processings in the image pickup apparatus of Embodiment 1.

FIG. 2 is a block diagram showing a basic structure of an image pickup apparatus.

FIG. 3 is a function block diagram showing a detailed structure of an image coding apparatus.

FIG. 4 schematically shows a table in which a relation between a resolution setting and a reference mode is stored.

FIG. 5 schematically shows a table in which a relation between a setting of image frame rate and a reference mode is stored.

FIG. 6 schematically shows a table in which a relation between a resolution setting for images and a reference mode is stored.

FIG. 7 schematically shows a table in which a relation between a setting of image quality and compression ratio for an image and a reference mode is stored.

FIG. 8 schematically shows a table in which a relation between a setting of image shooting mode and a reference mode is stored.

FIG. 9 schematically shows a table in which a relation between a free space of a recording medium and a reference mode is stored.

FIG. 10 schematically shows a table in which a relation between a free space of a recording medium and a reference mode is stored.

FIG. 11 schematically shows a table in which a relation between an image shooting mode and a reference mode is stored.

FIG. 12 shows an example where moving images are coded by the MPEG-4 scheme.

FIG. 13 shows an exemplary image where the moving images shown in FIG. 12 have bee decoded.

FIG. 14 is a flowchart showing a procedure for an image coding method according to an embodiment.

FIG. 15 is a flowchart showing a procedure for an image coding method according to an embodiment.

FIG. 16 is a flowchart showing a procedure for an image coding method according to an embodiment.

FIG. 17 shows a general structure of an image coding apparatus according to an embodiment.

FIG. 18 shows an example of a coded data sequence according to an embodiment.

FIG. 19 shows another example of a coded data sequence according to an embodiment.

FIG. 20 shows still another example of a coded data sequence according to an embodiment.

FIG. 21 shows still another of a coded data sequence according to an embodiment.

FIG. 22 shows a general structure of an image decoding apparatus according to an embodiment.

FIG. 23 is a flowchart showing a procedure for an image coding method according to an embodiment.

FIG. 24 is a flowchart showing a procedure for an image coding method according to an embodiment.

### THE BEST MODE FOR CARRYING OUT THE INVENTION

### First Embodiment

### Embodiment 1

An image coding apparatus and an image pickup apparatus according to the present embodiment are realized as a circuit for the coding and a digital camera including said circuit. This circuit for the coding selects a reference mode for image coding according to a resolution setting for an image shot by the digital camera. More specifically, a reference mode with a smaller processing load is selected at high-resolution capturing whereas a reference mode with a higher processing load is selected at non-high-resolution capturing. When this is made into a structure such that a single reference mode only is used, the selection of a reference mode must be designed in accordance with the high-resolution capturing, so that the compression ratio or image quality cannot be given the priority until such a time for non-high-resolution capturing. According to the present embodiment, the high compression ratio and high quality of image can be achieved at the time other than the high-resolution capturing.

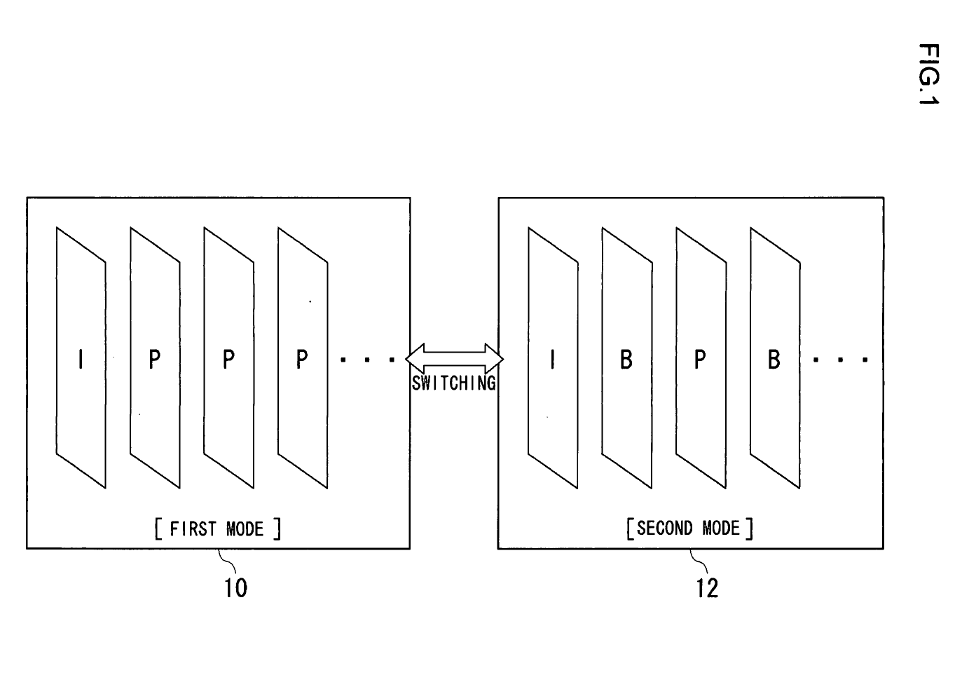

FIG. 1 schematically shows two kinds of coding processings in the image pickup apparatus of Embodiment 1. The image pickup apparatus according to the present embodiment has, as the reference mode in the coding processing, at least a first mode 10 and a second mode 12 and selects either mode in accordance with a resolution setting for shooting. In the first mode 10, an image is coded using I pictures or I-VOP and P pictures or P-VOP only, and B pictures or B-VOP are not used. In the second mode 12, on the other hand, an image is coded using I pictures or I-VOP, P pictures or P-VOP and B pictures or B-VOP. In this manner, in the first mode 10 and the second mode 12 the difference lies in whether B pictures are produced or not. In the case of the second mode 12 where B pictures are generated, the data compression ratio and the image quality are higher than in the first mode 10 but the load due to the coding processing is large. At high-resolution capturing, there are cases where the computation required for the bidirectional coding that produces B pictures exceeds its capacity. Therefore the first mode 10 where no B pictures is generated is selected as the reference mode at high-resolution capturing.

For example, in the case of MPEG-4 scheme, MPEG4-SP (Simple Profile) that does not generate B-VOP may be used in the first mode 10 whereas MPEG4-ASP (Advanced Simple Profile) that generates B-VOP may be used in the second mode 12. Note that whenever “I picture”, “P picture” and “B picture” appear in what is to follow, they contain also “I-VOP”, “P-VOP” and “B-VOP”, respectively. Also, whenever “frame” is mentioned, this may indicate a field wherein a frame is constituted by two fields.

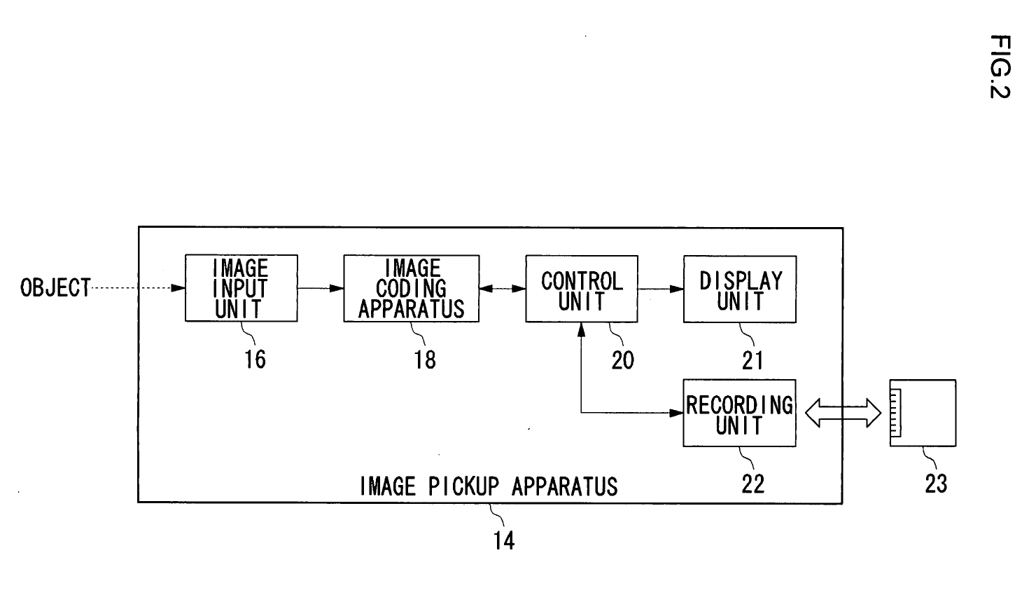

FIG. 2 is a block diagram showing a basic structure of an image pickup apparatus. The image pickup apparatus 14 is a digital camera capable of taking the moving images. The image pickup apparatus 14 is comprised of an input unit 16, an image coding apparatus 18, a control unit 20, a display unit 21 and a recording unit 22. The image input unit 16 acquires optically an image of an object, converts it to an electric signal and sends it to the image coding apparatus 18. The image coding apparatus 18 codes the image signal received from the image input unit 16 and sends it to the control unit 20. The control unit 20 sends the image coded by the image coding apparatus 18 to the recording unit 22 and also sends the same to a display unit 21 based on an instruction from a user. The display unit 21 displays the image sent from the control unit 20, on a liquid crystal screen. The recording unit 22 stores the image received from the control unit 20, in a recording medium 23 mounted on the recording unit 22.

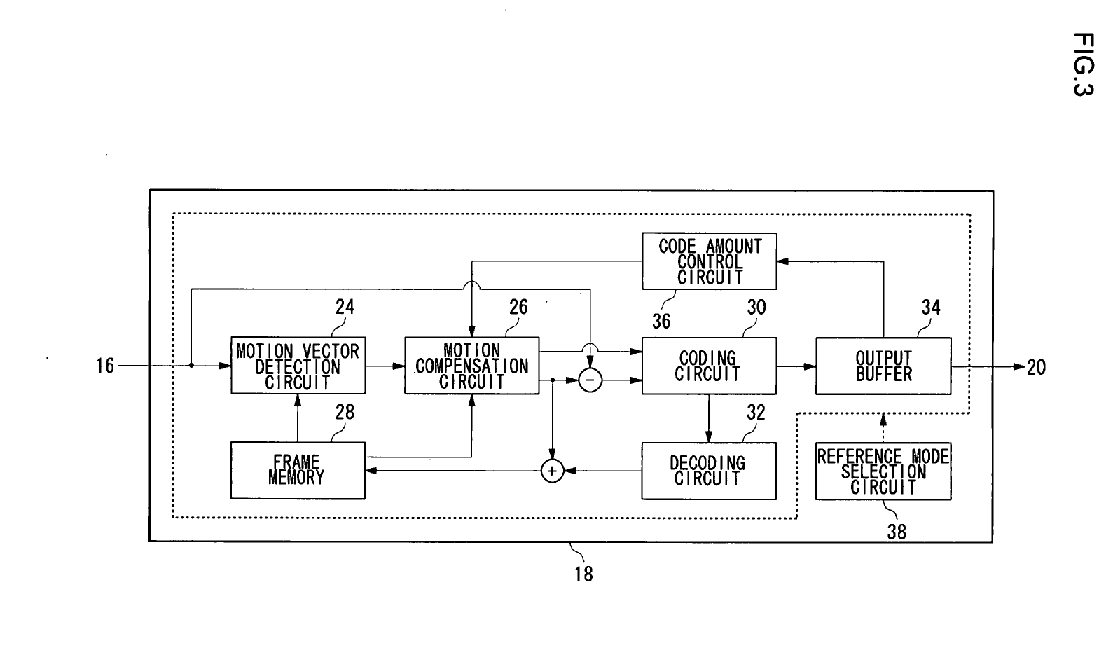

FIG. 3 is a function block diagram showing a detailed structure of an image coding apparatus. The image coding apparatus 18 includes a motion vector detection circuit 24, a motion compensation circuit 26, a frame memory 28, a coding circuit 30, a decoding circuit 32, an output buffer 34, a code amount control circuit 36 and a reference mode selection circuit 38.

An image inputted from the image input unit 16 (this image will be referred to as “current frame” hereinafter) is sent to the motion vector detection circuit 24. The motion vector detection circuit 24 detects a motion vector between an image, stored beforehand in the frame memory 28, which is to be referred to (this image will be referred to “reference frame” hereinafter) and a current frame. The motion compensation circuit 26 acquires from the code amount control unit 36 a value of quantization step used for quantization, and determines quantization factors thereof and a reference mode of macroblock. The motion vector detected by the motion vector detection circuit 24 and the quantization factors and macroblock reference mode determined by the motion compensation circuit 26 are sent to the coding circuit 30. Also, the motion compensation circuit 26 sends to the coding circuit 30 a difference between a reference value on macroblocks and an actual value, as a reference error.

The coding circuit 30 codes the reference error by using the quantization factors and sends it to the output buffer 34. The coding circuit 30 sends the quantized reference error and the quantization factors to the decoding circuit 32. The decoding circuit 32 decodes the quantized reference error, based on the quantization factors, and sends the sum of the decoded reference error and the reference value from the motion compensation circuit 26, which serves as the decoded image, to the frame memory 28. This decoded image is sent to the motion vector detection circuit 24, as a reference frame in a case when this decoded image is referred to in a coding processing of subsequent images. The code amount control unit 36 acquires a state of the accumulated amount in the output buffer 34 and generates a value of quantization step used for the next quantization, in accordance with the state of the accumulated amount.

The reference mode selection circuit 38 determines whether or not the bidirectional coding is to be used as inter-frame coding, according to the execution environment for image coding in the image pickup apparatus 14, namely, the resolution setting here for images to be captured. That is, the reference mode selection circuit 38 selects a frame reference mode from among the intra-frame coding, the forward coding and the bidirectional coding, and sends information indicative of a frame reference mode to each circuit constituting the image coding unit 18. In the case when no bidirectional coding is used, the reference mode selection circuit 38 sends information indicating that global motion compensation is not used, as the information indicative of the frame reference mode, to the coding circuit 30. In the case when the bidirectional coding is used, the reference mode selection circuit 38 sends information indicating that the global motion compensation is used, as the information indicative of the frame reference mode, to the coding circuit 30. When the coding circuit 30 acquires the information indicating that the global motion compensation is used, the coding circuit 30 performs the coding as a global motion vector if a vector in the vertical direction is zero and a vector in the horizontal direction is zero in a motion vector in the forward coding mode.

It is to be noted that the reference mode selection circuit 38 may be composed of an LSI for determining the reference mode based on a parameter indicative of an execution environment for code processing or may be formed by a combination of a system register that stores the information used for such determination and a CPU.

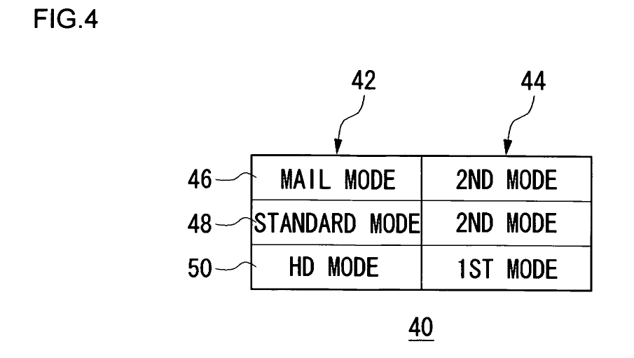

FIG. 4 schematically shows a table in which a relation between a resolution setting and a reference mode is stored. A mode table 40 has a resolution setting space 42 and a reference mode space 44. The reference mode selection circuit 38 according to the present embodiment selects a reference mode depending on which mode the resolution setting is set to as the execution environment for image coding. Information indicating which mode the resolution setting is set to is acquired from the control unit 20.

A mail mode 46 in which a relatively low resolution of 320×240 dots is set, a standard mode 48 in which a normal resolution of 640×480 dots is set and an HD mode 50 in which a relatively high resolution of 1280×720 is set are specified in the resolution setting space 42 as the resolution setting for an image. As a reference mode, a second mode 12 is determined in correspondence to the mail mode 46 and the standard mode 48, and a first mode 10 is determined in correspondence to the HD mode 50. That is, in the mail mode 46 and the standard mode 48, the second mode 12 is used with the priority given to high compression ratio and image quality. On the other hand, the computational load due to the large number of dots in the bidirectional coding for producing B pictures becomes excessively large in the HD mode 50, so that the first mode 10 in which the processing load is relatively small is used. As a result, the situation in which the computation goes beyond the capacity depending on an execution environment for the coding processing can be avoided, so that the image coding unit 18 can perform the coding processing in an appropriate amount of processing time under any setting of resolution.

### Embodiment 2

An image coding apparatus and an image pickup apparatus according to the present embodiment differs from Embodiment 1 in that the reference mode for image coding is selected, as an execution environment for the coding processing, according to the setting of a frame rate for an image to be captured. More specifically, the reference mode in which the bidirectional coding is used with the priority given to high compression ratio and image quality is selected at high frame-rate capturing. If, on the other hand, the frame rate is too low, there will be cases where the motion vector cannot be detected because the intervals from the preceding and subsequent frames are too large. Hence, the bidirectional referencing might rather cause the image quality to degrade. In the light of this, the reference mode in which the bidirectional coding is not used is selected at a low frame rate. Here, in a case where a structure is implemented such that a single reference mode only is used, the selection of a reference mode must be designed in accordance with the low frame-rate capturing. Thus, the reduction in compression ratio and image quality results and continues until the shooting mode is switched to the high frame-rate capturing. According to the present embodiment, a high compression ratio and image quality can be achieved at least at a high frame rate.

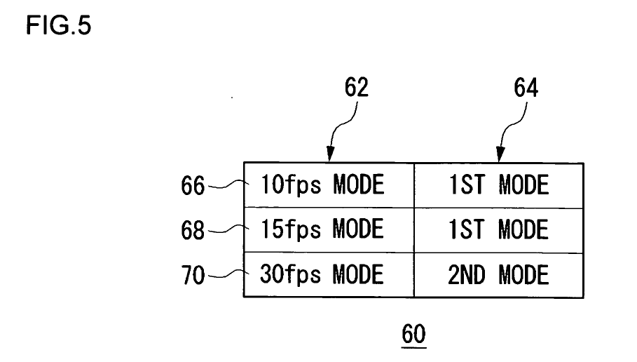

FIG. 5 schematically shows a table in which a relation between a frame rate setting for an image and a reference mode is stored. A mode table 60 has a frame rate setting space 62 and a reference mode space 64. The reference mode selection circuit 38 according to the present embodiment selects a reference mode depending on which mode the frame rate setting is set to as the execution environment for image coding. Information indicating which mode the frame rate setting is set to is acquired from the control unit 20.

A 10-fps mode 66 of a relatively low frame rate, a 15-fps mode 68 of an intermediate frame rate and a 30-fps mode 70 of a standard high frame rate are specified in the frame rate setting space 62 as the frame rate setting for an image. As a reference mode, a first mode 10 is determined in correspondence to the 10-fps mode 66 and the 15-fps mode 68, and a second mode 12 is determined in correspondence to the 30-fps mode 70. That is, in the 30-fps mode 70 the second mode 12 is selected with the priority given to high compression ratio and image quality. On the other hand, the frame rate is too low in the 10-fps mode 66 and the 15-fps mode 68, so that the first mode 10 in which no bidirectional coding is used is selected to avoid the situation where the motion vector cannot be detected from the preceding and subsequent frames. Thereby, the image coding unit 18 can perform the coding processing with an appropriate image quality and compression ratio under any setting of frame rates.

### Embodiment 3

An image coding apparatus according to the present embodiment shares the same feature as with the Embodiment 1 in that the reference mode is selected, as an execution environment for the coding processing, according to the resolution setting for images to be captured. Although the reference mode in which the bidirectional coding is used is selected, at high-resolution capturing, with the priority given to the high compression ratio and image quality, there is a possibility that the compression ratio and image quality is raised to a level more than necessary if the bidirectional coding is used at low-resolution capturing. In the light of this, the reference mode in which the bidirectional coding is not used is selected, at low-resolution capturing, with the priority given to the processing speed and the load reduction. If a structure is implemented such that a single reference mode only is used, the selection of a reference mode must be designed in accordance with either the high-resolution capturing or the low-resolution capturing, so that it is difficult to optimize the compression ratio and image quality in response to the environment. According to the present embodiment, the compression ratio and image quality suitable for the execution environment for coding processing can be achieved.

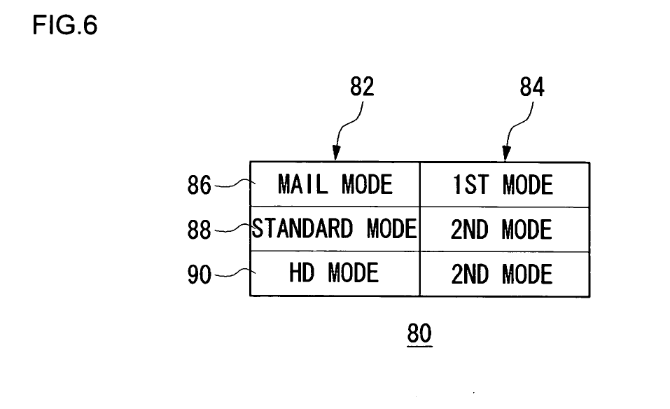

FIG. 6 schematically shows a table in which a relation between a resolution setting for images and a reference mode is stored. A mode table 80 has a resolution setting space 82 and a reference mode space 84. The reference mode selection circuit 38 according to the present embodiment selects a reference mode depending on which mode the resolution setting is set to as the execution environment for image coding. Information indicating which mode the resolution setting is set to is acquired from the control unit 20.

Similar to the Embodiment 1, a mail mode 86, a standard mode 88 and an HD mode 50 are specified in the resolution setting space 82 as the resolution setting for an image. As a reference mode, a first mode 10 is determined in correspondence to the mail mode 86, and a second mode 12 is determined in correspondence to the standard mode 88 and the HD mode 90. That is, in the standard mode 88 and the HD mode 90, the second mode 12 is used with the priority given to high compression ratio and image quality. On the other hand, in the mail mode 86 the number of dots in an image to be captured is small in the first place and the demand for high compression ratio and image quality is small. As a result, a great advantage cannot be found on the specifications even if the bidirectional coding is used at the cost of the processing load. Hence, the first mode 10 in which the processing load is relatively small is used in the mail mode 86. Thereby, the image coding unit 18 can perform the coding processing with an appropriate compression ratio and image quality under any setting of resolution.

### Embodiment 4

An image coding apparatus according to the present embodiment differs from the Embodiment 1 to Embodiment 3 in that the reference mode for image coding is selected, as an execution environment for the coding processing, according to the resolution setting or compression ratio for images to be captured. More specifically, at the time of image taking when the high image quality or high compression is set, a reference mode in which the bidirectional coding is used is selected with the priority given to the high compression ratio and image quality. However, at the time of image taking when the low image quality or low compression is set, a reference mode in which the bidirectional coding is not used is selected with the priority given to the processing speed or load reduction. Here, in a case where a structure is implemented such that a single reference mode only is used, the selection of a reference mode must be designed in accordance with either environment of the image taking under high image quality and high compression or the image taking under low image quality and low compression. Hence, it is difficult to optimize the compression ratio and image quality in response to the environment. According to the present embodiment, the compression ratio and image quality suitable for the execution environment for the coding processing can be achieved.

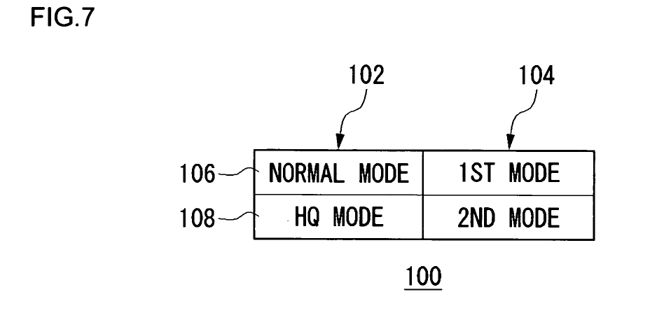

FIG. 7 schematically shows a table in which a relation between a setting of image quality and compression ratio for an image and a reference mode is stored. A mode table 100 has an image quality mode setting space 102 and a reference mode space 104. The reference mode selection circuit 38 according to the present embodiment selects a reference mode depending on which mode the setting of image quality and compression ratio is set to as the execution environment for image coding. Information indicating which mode the setting of image quality and compression ratio is set to is acquired from the control unit 20.

A normal mode 106 in which the image quality and the compression ratio are relatively low and an HQ mode 108 in which the image quality and the compression ratio are relatively high are specified in the image quality mode setting space 102 as the setting of image quality and compression ratio for an image. As a reference mode, a first mode 10 is determined in correspondence to the normal mode 106, and a second mode 12 is determined in correspondence to the HQ mode 108. That is, in the HQ mode 108, the second mode 12 is used with the priority given to high compression ratio and image quality. In the normal mode 106, a great advantage cannot be found on the specifications even if the bidirectional coding is used at the cost of the processing load, and therefore the first mode 10 is used. Thereby, the image coding unit 18 can perform the optimum coding processing under any setting of image quality and compression ratio.

### Embodiment 5

An image coding apparatus according to the present embodiment differs from the Embodiment 1 to Embodiment 4 in that the reference mode for image coding is selected, as an execution environment for coding processing, according to the characteristics of images to be taken. More specifically, at a normal-mode image shooting, a reference mode in which the bidirectional coding is used is selected with the priority given to the high compression ratio and image quality. However, since the movement is too large at a sport-mode image shooting and therefore there is a possibility that the motion vector is not detected, a reference mode in which the bidirectional coding is not used is selected. Here, in a case where a structure is implemented such that a single reference mode only is used, the selection of a reference mode must be designed in accordance with either environment of the image taking under the normal mode or the image taking under sport mode. Hence, it is difficult to optimize the compression ratio and image quality in response to the environment. According to the present embodiment, the compression ratio and image quality suitable for the execution environment for coding processing can be achieved.

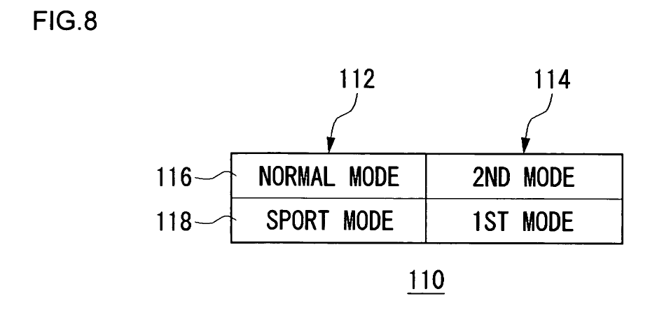

FIG. 8 schematically shows a table in which a relation between a setting of image shooting mode and a reference mode is stored. A mode table 110 has an image-shooting-mode setting space 112 and a reference mode space 114. The reference mode selection circuit 38 according to the present embodiment selects a reference mode depending on which mode the image-shooting-mode setting is set to as the execution environment for image coding. Information indicating which mode the image-shooting-mode setting is set to is acquired from the control unit 20.

A normal mode 116 and a sport mode 118 are specified in the image-shooting-mode setting space 112 as the image-shooting-mode setting. As a reference mode, a second mode 12 is determined in correspondence to the normal mode 116, and a first mode 10 is determined in correspondence to the sport mode 118. That is, in the normal mode 116, the second mode 12 is selected with the priority given to high compression ratio and image quality. On the other hand, if the motion vector is not detected because the movement of an object is too large and then the bidirectional coding is used, the reduction in image quality may result. Hence, the first mode 10 in which no bidirectional coding is used is selected in the sport mode 118. Thereby, the image coding unit 18 can perform the optimum coding processing under any setting of image shooting modes.

### Embodiment 6

An image coding apparatus according to the present embodiment differs from the Embodiment 1 to Embodiment 5 in that the reference mode for image coding is selected, as an execution environment for coding processing, according to the remaining free space of a recoding medium that stores the images captured. More specifically, if the remaining free space of a recording medium is smaller than a predetermined amount, a reference mode, having a relatively high compression ratio, in which the bidirectional coding is used is selected. And if the remaining free space of a recording medium larger than the predetermined amount, a reference mode, having a relatively low compression ratio, in which the bidirectional coding is not used is selected. Here, in a case where a structure is implemented such that a single reference mode only is used, the reference mode must be designed in accordance with either environment of a case where the free space of a recording medium is larger than a predetermined value or a case where it is less than the predetermined value. Hence, it is difficult to optimize the compression ratio in response to the environment. According to the present embodiment, the compression ratio suitable for the execution environment for coding processing can be achieved.

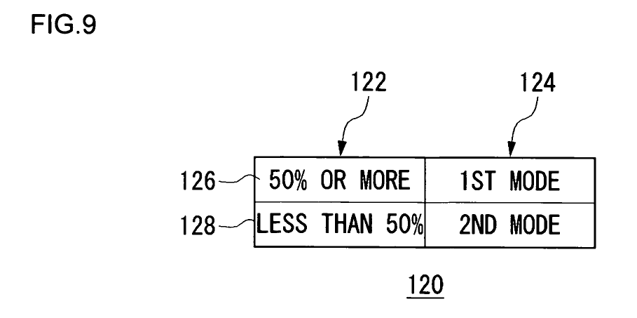

FIG. 9 schematically shows a table in which a relation between a free space of a recording medium and a reference mode is stored. A mode table 120 has a free space column 122 and a reference mode column 124. The reference mode selection circuit 38 according to the present embodiment selects a reference mode as the execution environment for image coding, according as how much a free space is remaining. Information indicating the remaining free space of a recording medium is acquired from the control unit 20.

A first status 126 in which the free space is 50% or more and a second status in which the free space is less than 50% are specified in the free space column 122 as the free space of a recording medium. As a reference mode, a first mode 10 is determined in correspondence to the first status 126, and a second mode 12 is determined in correspondence to the second status 128. That is, in the first status 126, a sufficient free space remains in the recording medium, so that the first mode 10 of lower compression ratio is selected. On the other hand, the remaining free space of the recording medium is small in the second status 128 and therefore the second mode 12 is selected with the priority given to the high compression ratio. Thereby, the image coding unit 18 can perform the optimum coding processing irrespectively of the remaining free space of the recording medium.

### Embodiment 7

An image coding apparatus according to the present embodiment differs from the Embodiment 1 to Embodiment 6 in that the reference mode for image coding is selected, as an execution environment for coding processing, according to the type of a recoding medium that stores the images captured. More specifically, the level of a bit rate indicative of a data transfer rate to the recording medium differs depending on the type of a recording medium used. Hence, when a recording medium of a high bit rate is mounted, a reference mode, having a relatively low compression ratio, in which no bidirectional coding is used is selected. And when a recording medium of a low bit rate is mounted, a reference mode, having a relatively high compression ratio, in which the bidirectional coding is used is selected. Here, in a case where a structure is implemented such that a single reference mode only is used, the reference mode must be designed in accordance with either medium with the high bit rate or the low bit rate. Hence, it is difficult to optimize the compression ratio in response to the environment. According to the present embodiment, the compression ratio suitable for the execution environment for coding processing can be achieved.

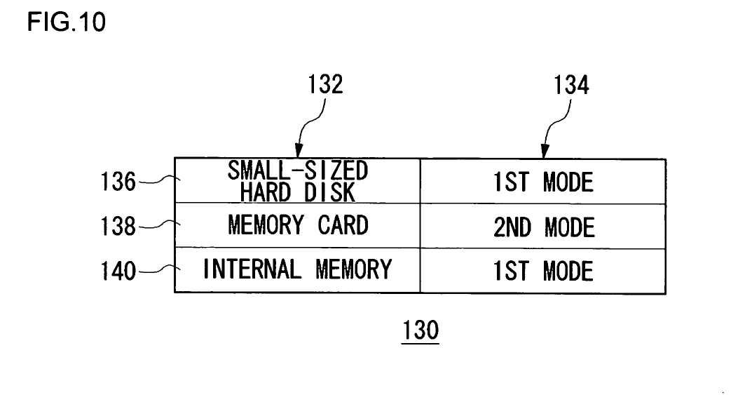

FIG. 10 schematically shows a table in which a relation between a free space of a recording medium and a reference mode is stored. A mode table 130 has a recording-medium-type space 132 and a reference mode space 134. The reference mode selection circuit 38 according to the present embodiment selects a reference mode as the execution environment for image coding, in accordance with the type of a recording medium. Information indicating the type of a recording medium is acquired from the control unit 20.

A small-sized hard disk 136 of high bit rate, a memory card 138 of low bit rate and an internal memory 140 of high bit rate are specified in the recording-medium-type space 132 as the type of a recording medium. As a reference mode, a first mode 10 is determined in correspondence to the small-sized hard disk 136 and the internal memory 140, and a second mode 12 is determined in correspondence to the memory card 138. That is, in the case of the small-sized hard disk 136 and the internal memory 140, they are of a high bit rate, so that the first mode 10 in which the compression ratio is low and the data size is relatively large is selected. On the other hand, in the case of the memory card 138, it is of a low bit rate, so that second mode 12 in which the compression ratio is high and the data size is relatively small is selected. Thereby, the image coding unit 18 can perform the optimum coding processing irrespectively of the type of the recording medium used.

### Embodiment 8

An image coding apparatus according to the present embodiment differs from the Embodiment 1 to Embodiment 7 in that the reference mode for image coding is selected, as an execution environment for coding processing, according to whether an image shooting mode is one compatible with a special reproduction or not. More specifically, in the case when images are captured under a mode compatible with a special reproduction like 2×reproduction, each frame can be coded in the order of I picture, B picture, P picture and B picture wherein a structure is such that the B picture is inserted every other picture. In this case, the 2× reproduction can be achieved by skipping the B pictures at the time of reproduction, so that a great advantage can be enjoyed on the specifications if the bidirectional coding for generating B pictures is used. On the other hand, in the case when images are captured under a mode not compatible with a special reproduction like the 2× reproduction, a great advantage cannot be found on the specifications even if the B pictures can be generated. Thus, the first mode 10 is selected then. Here, in a case where a structure is implemented such that a single reference mode only is used, the selection of the reference mode must be designed in accordance with either image taking compatible with a special reproduction or not compatible therewith. Hence, it is difficult to optimize the compression ratio in response to the environment. According to the present embodiment, a coding method suitable for the execution environment for coding processing can be achieved.

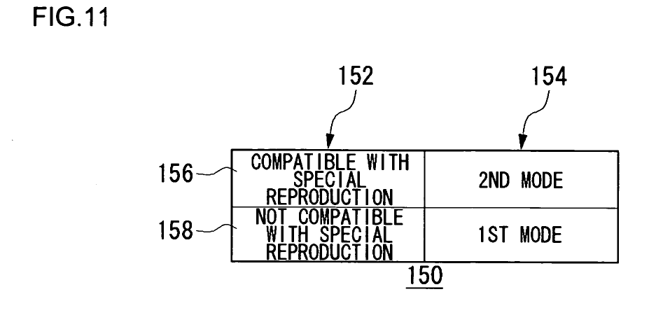

FIG. 11 schematically shows a table in which a relation between an image shooting mode and a reference mode is stored. A mode table 150 has a image-shooting-mode space 152 and a reference mode space 154. The reference mode selection circuit 38 according to the present embodiment selects a reference mode as the execution environment for image coding, depending on whether it is an image shooting mode compatible with a special reproduction or not compatible therewith.

An image shooting mode 156 compatible with a special reproduction like a 2× reproduction and an image shooting mode 158 not compatible with a special reproduction are specified in the image-shooting-mode space 152 as the type of an image shooting mode. As a reference mode, a second mode 12 is determined in correspondence to the image shooting mode 156 compatible with a special reproduction, and a first mode 10 is determined in correspondence to the image shooting mode 158 not compatible with a special reproduction. Thereby, the image coding unit 18 can perform the optimum coding processing according to the image shooting mode.

In each Embodiment, a structure has been explained where the reference mode is selected according to each parameter such as resolution setting, frame rate setting and image quality setting. In a modification, the reference mode may be selected according to other parameters, in the execution environment for coding processing, such as line speed, line congestion factor and throughput at a forwarding destination. In such a case, a structure may be such that the first mode 10 of a low compression ratio is selected when the line speed is high, the line congestion factor is small and the throughput at a forwarding destination is high whereas the second mode 12 is selected otherwise.

In another modification, the reference mode may be selected according to the magnitude of power consumed by the image pickup apparatus 14 and the remaining battery capacity, as the other parameters in the execution environment for coding processing. In such a case, a structure may be such that the first mode 10 of less load is selected when the power consumption is high and the remaining battery level is low whereas the second mode 12 is selected otherwise.

In each Embodiment and each modification, the various types of parameters, for the execution environment for coding processing, which the reference mode selection circuit 38 refers to have been exemplified. As still another medication, the reference mode may be selected according to two or more parameters among these various types of parameters. In such a case, they may be stored in the mode table in a manner that a combination of each parameter is associated with the reference mode most suitable for said combination.

### Background Technology of Second to Fifth Embodiments

In MEPG(Motion Picture Experts Group)-4 which is a standard for the compression coding scheme for moving images, when data on difference between a macroblock having an object image which is subjected to the coding and a macroblock, corresponding to said macroblock, within a reference image to be referred to at the time of coding said object image is practically zero, the coding is performed using a “not_coded” flag indicating that it is a copy of the reference image. Hence, the reduction in code amount is sought. Also, when, at the time of coding the object image by an inter-frame bidirectional predictive mode, the coding is performed using a “not_coded” flag indicating that a macroblock in P-VOP serving as a reference image posterior to said object image is a copy of a corresponding macroblock in a reference image anterior to said object image, the corresponding macroblock in the object image is also regarded as the corresponding macroblock in the past reference image (See Japanese Patent Application Laid-Open No. Hei 08-154250, for instance). As a result thereof, the code amount can be considerably reduced.

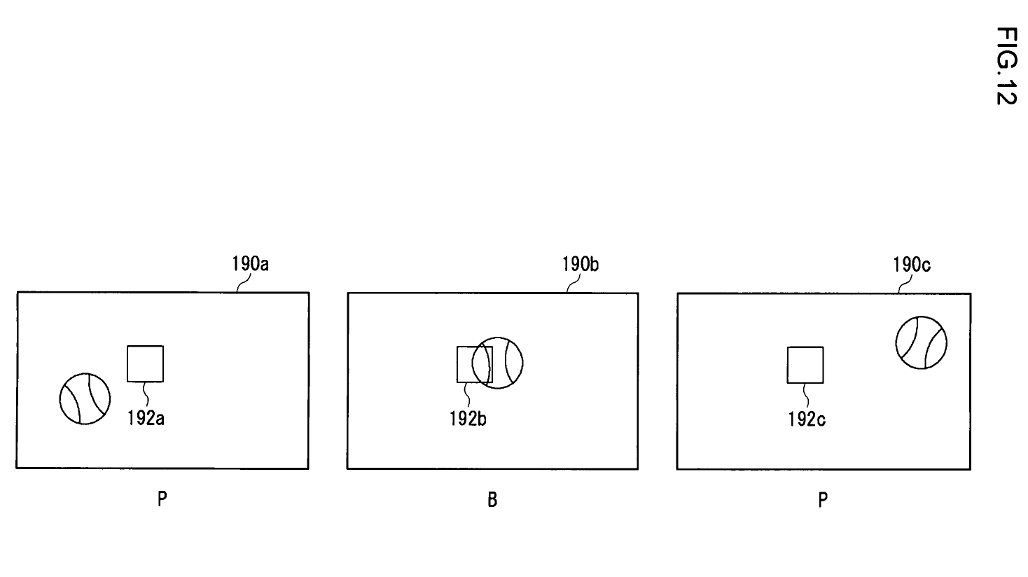

The above-described technique will be explained using specific examples. FIG. 12 shows an example where moving images are coded by the MPEG-4 scheme. In the example shown in FIG. 12, three successive images 190a, 190b and 190c are coded as P-VOP, B-VOP and P-VOP, respectively. First, the image 190a is compressed and coded using the inter-frame forward predictive mode with I-VOP or P-VOP, located immediately prior thereto, as a reference image. Next, the image 190c is compressed and coded using the forward predictive mode with the image 190a, which is P-VOP located immediately prior thereto, as a reference image. At this time, a macroblock 192c is almost the same image as a macroblock 192a in the past reference image 190a and the difference is practically zero, and therefore the coding is performed using the “not_coded” flag. At a decoding, the image of the macroblock 192a is copied to the macroblock 192c. Subsequently, the image 190b is compressed and coded using the bidirectional predictive mode with the image 190a as a past reference image and the image 190c as a future reference image. At this time, the macroblock 192c of the future reference image 190c corresponding to the macroblock 192b of the image 190b which is to be coded is coded using the “not_coded” flag, so that the macroblock 192b of the image 190b is similarly coded using the “not_coded” flag. At a decoding, the image of the macroblock 192a is copied to the macroblock 192b.

### Problems to be Solved by Second to Fifth Embodiments

Accordingly, when in the current MPEG-4 standard a macroblock coded using the “not_coded” flag exists in P-VOP which is a future reference image of B-VOP, the macroblock of B-VOP corresponding to said macroblock is processed also as a copy of the past reference image and the data on a difference relative to the reference data is not coded.

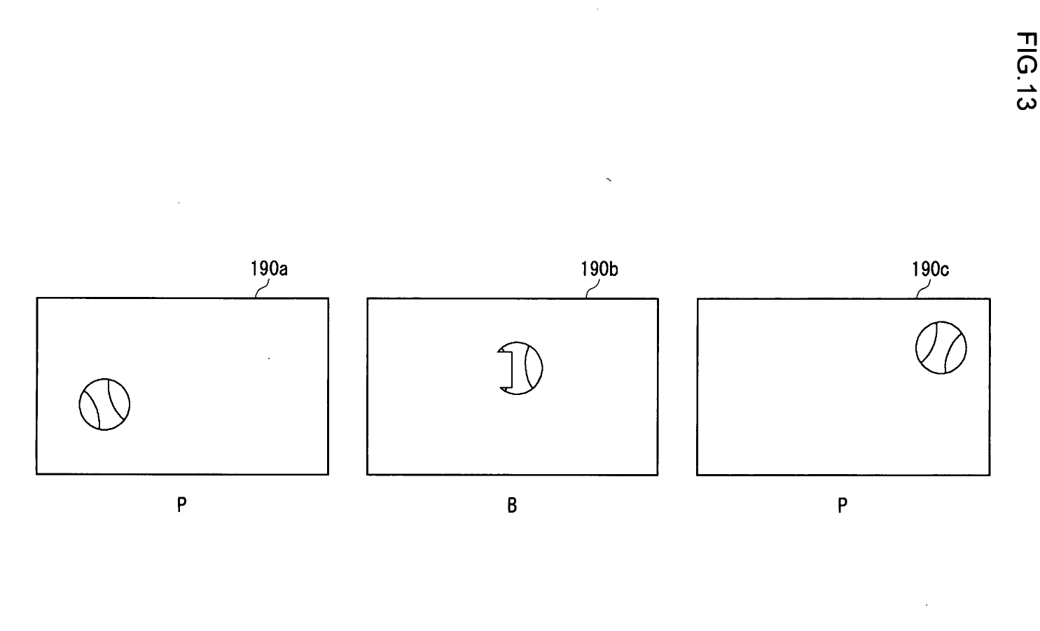

However, there are cases where the macroblock 192b of the image 190b is an image differing from the macroblocks 192a and 192c because it receives a flash of light or an object passes therethough at the instant the image 190b is taken. In such a case, the macroblock 192a is copied to the macroblock 192b at a decoding. As a result, there may be a missing part in the image as shown in FIG. 13 and the image quality may degrade.

In view of the above-mentioned circumstances, an object of the second to the fifth embodiment is to provide a technology by which to reduce the degradation of the image quality at the time of decoding moving images.

### Second Embodiment

A structure of an image coding apparatus 18 according to the present embodiment is similar to the structure of the image coding apparatus 18 according to the first embodiment shown in FIG. 3. The image coding apparatus 18 according to the present embodiment performs the coding of moving images compliant with MPEG-4. In a case where the coding is performed in compliance with the standard of MPEG-4 and the coding is then performed with a profile containing B-VOP, if, in P-VOP that B-VOP refers to in a backward direction, there exists a macroblock coded with a “not_coded” flag, it is also regarded as a copy of a past reference frame in B-VOP. As a result, there are cases where an image has a missing part as already mentioned above. Thus, according to the present embodiment, the coding scheme in a future reference frame is changed so that it does not form a copy of the past reference frame in B-VOP. More specifically, even if the motion vector is zero, B-VOP will be provided with difference data in a manner such that it is treated as a global motion vector. Thereby, the above problems can be avoided within the current MPEG-4 standard and the quality of compressed images can be enhanced. In what is to follow, a description will be given centering around points different from the first embodiment.

The reference mode selection circuit 38 switches the frame prediction mode among intra-frame coding, inter-frame forward predictive coding and inter-frame bidirectional predictive coding, and outputs frame prediction mode information to the other circuits. According to the present embodiment, the reference mode selection circuit 38 first acquires a profile used at the time of coding the moving images, and determines whether it contains the inter-frame bidirectional predictive mode or not. As a profile for MPEG-4, there are SP (Simple Profile), ASP (Advanced Simple Profile) and the like. Among these, SP is a profile in which I-VOP coded by the intra-frame coding and P-VOP coded by the inter-frame forward predictive mode are combined together but B-VOP coded by the inter-frame bidirectional predictive mode is not contained. In contrast thereto, ASP is a profile in which B-VOP can be used in addition to I-VOP and P-VOP. The reference mode selection circuit 38 determines, from information on the type and the like of moving images, whether the inter-frame bidirectional predictive mode is contained or not.

When it is determined that the moving images to be coded are coded while they contain the inter-frame bidirectional predictive mode, the reference mode selection circuit 38 outputs information indicating that a global motion compensation is used, as information representing a frame prediction mode for coding a future reference frame of B-VOP coded in the inter-frame bidirectional predictive mode. At this time, the coding circuit 30 performs the coding on those whose motion vector in the inter-frame forward predictive mode is a zero vector, in a manner that the global motion vector is assumed to be a zero vector. Or, the coding circuit 30 performs the coding on a macroblock in which the motion vector in the inter-frame predictive mode is a zero vector and the difference data with the past reference frame is practically zero, namely a macroblock coded by the “not_coded” flag, using the global motion compensation. More specifically, when the coding circuit 30 performs the coding on a future reference frame of B-VOP, it codes the frame as S-VOP that contains a global motion vector. By doing so, even if a macroblock, in which there is a frame that B-VOP refers to in a backward direction, is practically the same as a macroblock corresponding to a frame referred to in a forward direction, the macroblock corresponding to B-VOP can be provided with difference data relative to a reference image. Thereby, the loss of image can be prevented and the image quality of decoded images can be enhanced.

The reference mode selection circuit 38 may switch only the P-VOP that B-VOP refers to in a backward direction, to S-VOP with global motion vectors. Or, if for a profile in which B-VOP exists, the reference mode selection circuit 38 may switch all P-VOP to S-VOP with global motion vectors. When a “not_coded” macroblock appears during the coding of P-VOP, the reference mode selection circuit 38 may switch said P-VOP to S-VOP with global motion vectors. Or, when the “not_coded” macroblock appears a predetermined number of times or more, the reference mode selection circuit 38 may switch said P-VOP to S-VOP with global motion vectors.

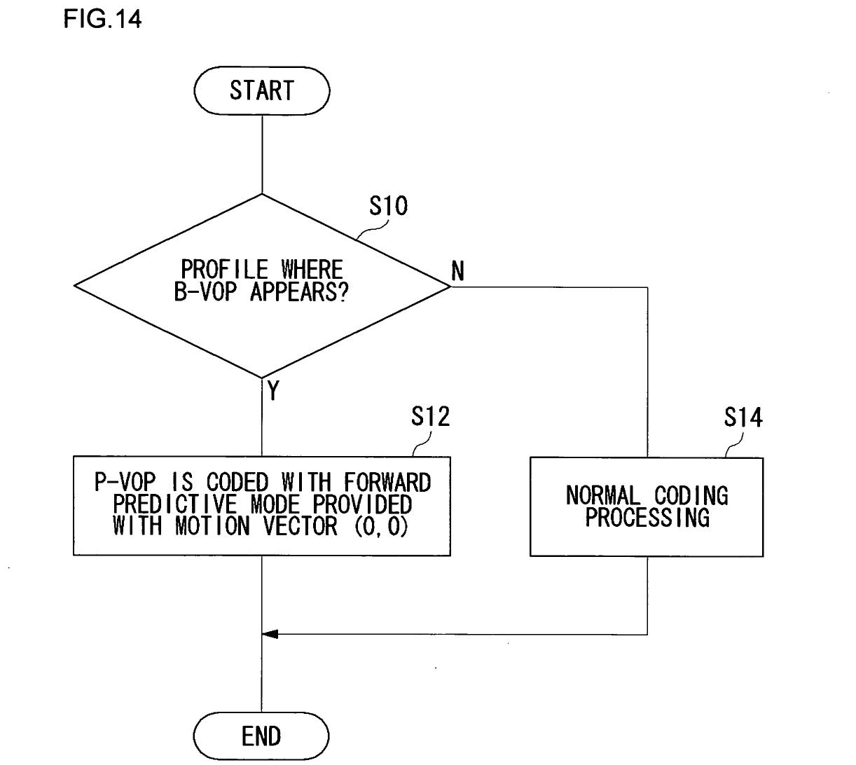

FIG. 14 is a flowchart showing a procedure for an image coding method according to the present embodiment. First, the reference mode selection circuit 38 acquires a profile used at the time of coding the moving images, and determines whether B-VOP appears or not (S10). If it is the profile where B-VOP does not appear (N of S10), the image coding apparatus 18 will perform the coding of moving images by a normal method without carrying out a special processing (S14). If it is the profile where B-VOP appears (Y of S10), the reference mode selection circuit 38 will output frame predictive mode information indicating that, at the time of coding P-VOP, the coding is performed using the forward predictive mode provided with the global motion vector of (0, 0) (S12). Upon receipt of an instruction from the reference mode selection circuit 38, the coding circuit 30 codes images to be coded as S-VOP using the global motion vector of (0, 0).

### Third Embodiment

The image coding apparatus 18 according to the present embodiment performs the coding of moving images compliant with MPEG-4. In a case where the coding is performed complying with the standard of MPEG-4 and the coding is then performed with a profile containing B-VOP, if, in P-VOP that B-VOP refers to in a backward direction, there exists a macroblock coded with a “not_coded” flag, it is also regarded as a copy of the past reference frame in B-VOP. As a result, there are cases where an image has a missing part as already mentioned above. Thus, according to the present embodiment, the coding scheme in the future reference frame is changed so that it does not form a copy of the past reference frame in B-VOP. More specifically, even if in P-VOP there exists a macroblock which can be coded by the “not_coded” flag, the coding is performed by adding motion vector information indicating therein that the motion vector is a zero vector. Then, a macroblock of the corresponding B-VOP is provided with a motion vector or a coding parameter containing prediction error. Thereby, the above problems can be avoided within the current MPEG-4 standard and the quality of compressed images can be enhanced.

The structure of the image coding apparatus 18 according to the present embodiment is similar to that of the image coding apparatus 18 according to the first embodiment shown in FIG. 3. Hereinbelow, a description will be given mainly of what differs from the first embodiment.

According to the present embodiment, the reference mode selection circuit 38 first acquires a profile used at the time of coding the moving images, from a control circuit (not shown) that controls the entire image coding apparatus 18 or the like, and determines whether it contains the inter-frame bidirectional predictive mode or not. The profile may be set, through an instruction provided externally, by the control circuit. Instead, a structure may be such that the control circuit automatically sets the profile according to the usage environment of the image coding apparatus 18. As a profile for MPEG-4, there are SP (Simple Profile), ASP (Advanced Simple Profile) and the like. Among these, SP is a profile in which I-VOP coded by the intra-frame coding and P-VOP coded by the inter-frame forward predictive mode are combined together but B-VOP coded by the inter-frame bidirectional predictive mode is not contained. In contrast thereto, ASP is a profile in which B-VOP can be used in addition to I-VOP and P-VOP. The reference mode selection circuit 38 determines, from information on the type and the like of moving images, whether the inter-frame bidirectional predictive mode is contained or not.

Suppose that it is determined that the moving mages to be coded are coded while the inter-frame forward predictive mode and the inter-frame bidirectional mode are contained. Then, if, in P-VOP coded with the inter-frame forward predictive mode, a certain macroblock constituting the P-VOP exists in a past reference frame and said macroblock is determined to be practically the same as the macroblock located in the same position in the P-VOP, the reference mode selection circuit 38 will output the information indicating that information on a motion vector with an anterior predictive reference frame is appended into a coded data sequence instead of appending the “not_coded” flag. Upon receipt of this information, the coding circuit 30 codes the macroblock, which can be coded with a “not_coded” flag, by appending the motion vector which is a zero vector, without the use of the “not_coded” flag. As a result, even if a macroblock of a frame that B-VOP refers to in a backward direction is practically the same as the macroblock corresponding to a frame that it refers to in a forward direction, the corresponding macroblock of B-VOP can be provided with the coding parameters containing the information on a motion vector with a reference image and the predictive error. Thus, the loss of image can be prevented and the image quality of decoded images can be enhanced.

The reference mode selection circuit 38 may switch in a manner that the block which can be coded using the “not_coded” flag is coded, in the only P-VOP that B-VOP refers to in a backward direction, by appending the motion vector information. And if the profile is a profile in which B-VOP exists, the reference mode selection circuit 38 may switch in a manner that the block which can be coded using the “not_coded” flag is coded, in all of P-VOPs, by appending the motion vector information. If the “not_coded” macroblock has appeared more than or equal to a predetermined number of times, the reference mode selection circuit 38 may switch in a manner that, in said P-VOP, the macroblock which can be coded using the “not_coded” flag is coded by appending the motion vector information.

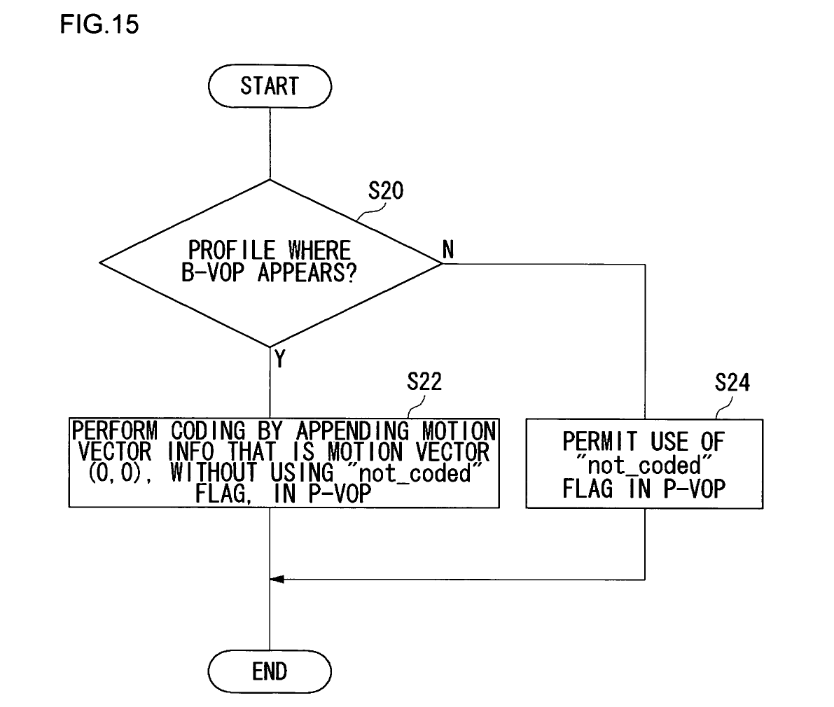

FIG. 15 is a flowchart showing a procedure for an image coding method according to the present embodiment. First, the reference mode selection circuit 38 acquires a profile used at the time of coding the moving images, and determines whether B-VOP appears or not (S20). If it is the profile where B-VOP does not appear (N of S20), the image coding apparatus 18 permits the use of the “not_coded” flag when the coding is performed in P-VOP (S24). If it is the profile where B-VOP appears (Y of S20), the reference mode selection circuit 38 will output frame predictive mode information indicating that, at the time of coding P-VOP, the motion vector is coded by appending the information on a motion vector which is (0, 0) even if the macroblock is a block capable of being coded using the “not_coded” flag (S22). Upon receipt of instructions from the reference mode selection circuit 38. The coding circuit 30 codes images to be coded.

### Fourth Embodiment

In the second embodiment, a method using a global motion vector has been presented as a method for coding P-VOP which is a future reference frame for B-VOP. In the third embodiment, a method was presented in which the motion vector information indicating a zero vector is appended even if there exists a macroblock capable of being coded with a “not_coded” flag. In either method, however, the code amount increases as compared with a case when the coding is performed using the “not_coded” flag.

That is, when the global motion vector is used, the flag indicative of whether the global motion vector is used or not is appended to all of macroblocks, so that the code amount increases as much as those flags appended thereto. Also, in the case where the motion vector information indicative of a zero vector is appended, the motion vector information is also appended to all of macroblocks which can be coded using the “not_coded” flag, so that the code amount increases as much as those appended thereto.

Thus, when a case of using the global motion vector is compared with a case of adding the motion vector information indicative of a zero vector, the code amount will be smaller for the case of adding the motion vector information indicative of a zero vector if the number of macroblocks which can be coded using the “not_coded” flag is small. If, however, the number of macroblocks which can be coded using the “not_coded” flag is large, the code amount will be smaller for the case of using the global motion vector.

In the light of this, to keep the increase of such a code amount to the minimum the image coding apparatus 18 according to the present embodiment can switch between the mode in which the coding is performed using the global motion vector as in the second embodiment and the mode in which the motion vector information indicative of a zero vector is added as in the third embodiment.

The general structure of an image coding apparatus 18 according to the present embodiment is the same as that of the image coding apparatus 18 according to the first embodiment, and partially differs in operation from the output buffer 34 and the reference mode selection circuit 38. A description will be given hereinbelow of distinctive features of the present embodiment and the description other than those will be omitted.

Suppose that it is determined that the moving images to be coded are coded in a manner that they contain the inter-frame forward predictive mode and the inter-frame bidirectional predictive mode. Then, if it is determined that, in P-VOP coded with the inter-frame forward predictive mode, a certain macroblock constituting the P-VOP exists in a past reference frame and said macroblock is determined to be practically the same as the macroblock located in the same position in the P-VOP, the reference mode selection circuit 38 will output the information indicating that information on a motion vector with an anterior predictive reference frame is appended into a coded data sequence instead of appending the “not_coded” flag. Upon receipt of this information, the coding circuit 30 codes the macroblock, which can be coded with a “not_coded” flag, by appending the motion vector which is a zero vector, without the use of the “not_coded” flag, and has this stored in the output buffer 34.

At the same time, the coding circuit 30 performs the coding on P-VOP which is a future reference frame of B-VOP in a manner such that those whose motion vector in the inter-frame forward predictive mode is a zero vector are regarded as those whose global motion vector is a zero vector, and also has these stored in the output buffer 34. Also, when it is coding the P-VOP which is a future reference frame of B-VOP, the coding circuit 30 counts the number of macroblocks which can be coded with the “not_coded” flag and communicates this number to the reference mode selection circuit 38.

When the number of macroblocks, which can be coded with the “not_coded” flag, notified from the reference mode selection circuit 38 becomes greater than or equal to a prescribed threshold value, the reference mode selection circuit 38 selects the information indicating that the global motion vector is used, as the information indicating a coding mode used to code P-VOP which is a future reference frame of B-VOP. This threshold value may be a value determined internally or may be specified externally by a user.

When the coding mode that the reference mode selection circuit 38 outputs is switched to the information indicating that the global motion vector is used, the coding circuit 30 stops a method of coding by appending the motion vector information which is a zero vector, continues at the same time a method of coding where the motion vector in the inter-frame forward predictive mode is a zero vector is coded using the global motion compensation, and then continuously has this coded data stored in the output buffer 34. After the coding of P-VOP is completed, the coded data sequence which has been coded using the global motion vector is outputted from the output buffer 34.

On the other hand, when the number of macroblocks which can be coded with the “not_coded” flag does not reach the prescribed threshold value and the coding of P-VOP which is a future reference frame of B-VOP has completed, the coding mode that the reference mode selection circuit 38 outputs is not switched and the method of coding by appending the motion vector information which is a zero vector continues to the end. After the coding of P-VOP has completed, the coded data sequence coded by appending the motion vector information which is a zero vector is outputted from the output buffer 34.

Note that, only in the P-VOP that B-VOP refers to in a backward direction, the reference mode selection circuit 38 may perform the coding by appending the motion vector information which is a zero vector or by using the global motion vector. In the case of a profile where there exists B-VOP, the coding may be performed by appending the motion vector information which is a zero vector or by using the global motion vector.

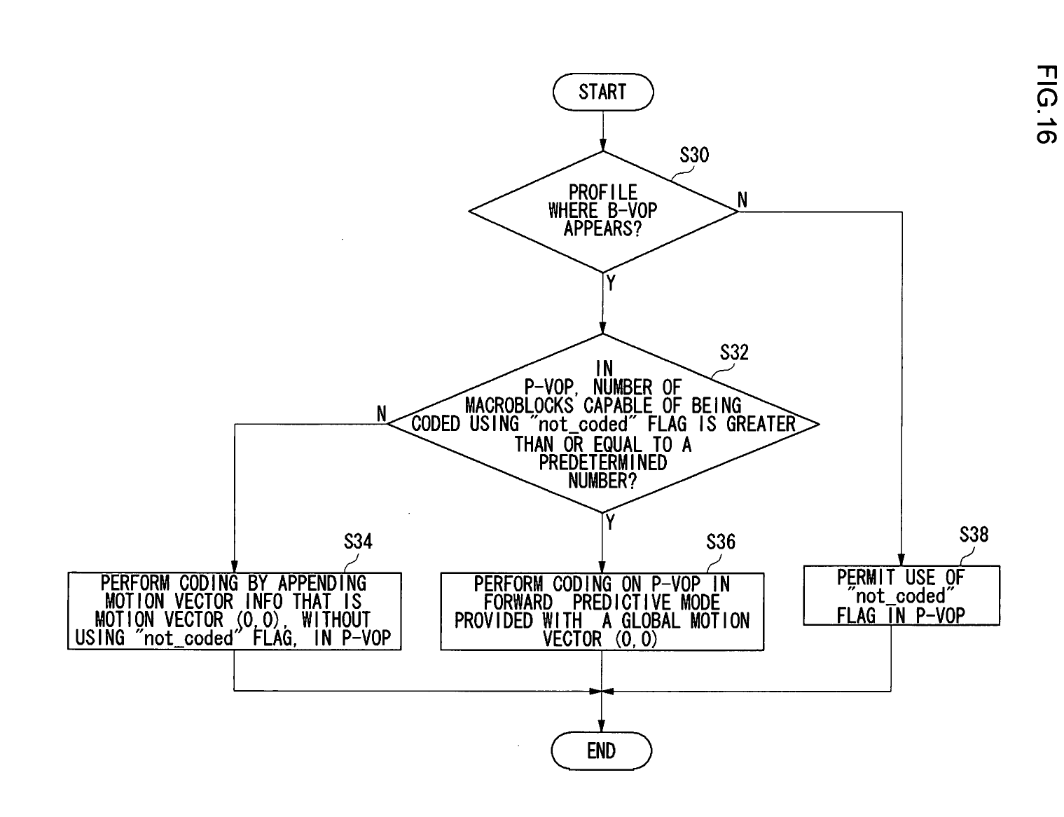

FIG. 16 is a flowchart showing a procedure for an image coding method according to the present embodiment. Firstly, the reference mode selection circuit 38 acquires a profile used at the time of coding the moving images, and determines whether B-VOP appears or not (S30). If it is the profile where B-VOP does not appear (N of S30), the image coding apparatus 18 permits the use of the “not_coded” flag when the coding is performed in P-VOP (S38). If it is the profile where B-VOP appears (Y of 30), it is determined whether the number of macroblocks which can be coded using the “not_coded” flag, at the time of coding P-VOP, is greater than or equal to a prescribed number or not (S32). If it is less than the prescribed number (N of S32), the reference mode selection circuit 38 will output frame predictive mode information indicating that the motion vector is coded by appending the information on a motion vector which is (0, 0) (S34). If it greater than or equal to the prescribed threshold value, the reference mode selection circuit 38 outputs frame coding mode information indicating that the coding is performed, at the time of coding P-VOP, using a forward predictive mode provided with a global motion vector (0, 0) (S36). The image coding apparatus 18 outputs a coded data sequence based on the frame coding mode information outputted from the reference mode selection circuit 38.

As described above, the following effects can be obtained in the image coding apparatus 18 according to the present embodiment.

1) P-VOP which is a future reference frame of B-VOP is coded by a coding mode where the global motion vector is used or a coding mode where the motion vector information of a zero vector (0, 0) is appended. Hence, even if a certain macroblock in a frame that B-VOP refers to in a backward direction is practically the same as the corresponding macroblock in the frame referred to in a forward direction, a corresponding macroblock of B-VOP can be provided with information on a motion vector with a reference image or a coding parameter containing prediction error. As a result, the loss of image can be prevented and the image quality of decoded images can be enhanced.

2) When P-VOP which is a future reference frame of B-VOP is coded, the coding mode for the P-VOP can be switched between a coding mode using the global motion vector or a coding method where the motion vector information which is a zero vector is appended, based on the number of macroblocks which can be coded using the “not_coded” flag. Thereby, a coding method with a satisfactory coding efficiency can be selected based on the number of macroblocks capable of being coded using the “not_coded” flag, so that the increase in code amount can be kept to the minimum.

In the present embodiment, the reference mode circuit 38 may provide two threshold values TH1 and TH2 (TH1<TH 2) for the number of blocks with “not_coded”. In such a case, when the number of macroblocks with “not_coded” is less than TH1, the use of a “not_coded” flag in P-VOP may be permitted. When the number of macroblocks with “not_coded” is greater than or equal to TH1 and less than TH2, the coding mode may be switched to one in which the blocks capable of being coded using the “not_coded” flag are coded by appending the motion vector information. When the number of macroblocks with “not_coded” is greater than or equal to TH2, the coding mode may be switched to one in which the coding is performed using the global motion vector.

In the present embodiment, when a future reference frame of P-VOP is coded, the selection between a mode in which a macroblock capable of being coded using a “not_coded” flag is coded using a global motion vector and a mode in which the coding is performed by appending a motion vector representing a zero vector may be not only made based on the number of macroblocks but also made externally. That is, an input unit may be provided in the image coding apparatus 18 and the selection may be made by a user's instruction via the input unit. Also, the selection may be made according to the specifications of a decoding apparatus at destination. For example, if the decoding apparatus at destination does not support the global motion vector, the mode in which the coding is performed by adding a motion vector representing a zero vector may be selected.

In the present embodiment, the coding circuit 30 employs parallely a coding method in which a macroblock capable of being coded using a “not_coded” flag is coded using a global motion vector and a coding method in which a motion vector representing a zero vector is appended. However, it is not limited thereto, and the coding circuit 30 may have the output buffer 34 store the macroblock capable of being coded using a “not_coded” flag, by performing only the coding in which the motion vector representing a zero vector is appended. In this case, if, at the time when the coding of a frame to be coded has been completed, the frame coding mode information outputted from the reference mode selection circuit 38 represents the coding mode in which a motion vector representing a zero vector is appended, then the coded data sequence stored in the output buffer 34 will be outputted as it is. If the frame coding mode information outputted from the reference mode selection circuit 38 represents the coding mode in which a global motion vector is used, the coded data sequence stored in the output buffer 34 is outputted after converting them into a coded data sequence using a global motion vector.

In the present embodiment, the coding mode is switched between the coding mode in which a global motion vector is used and the coding mode in which the motion vector information which is a zero vector is appended, based on the number of macroblocks capable of being coded using the “not_coded” flag. However, it is not limited thereto and the switching may be made based on the number of macroblocks capable of being coded using the “not_coded” flag contained in the coded frames in the past.

### Fifth Embodiment

In the present embodiment, if a difference from a macroblock of a frame referred to in a forward direction is small at the time when the coding is performed on a macroblock of B-VOP that refers to the macroblock, coded by a “not_coded” flag, in a backward direction, then the coding is performed using the “not_coded” flag, whereas if the difference is large, then difference data are coded. Then a flag (hereinafter simply referred to as “decision flag”) indicating whether the macroblock of a frame referred to in a forward direction is used as a copy or the difference data from the reference frame are decoded is inserted to the coded data sequence. When decoding B-VOP, an image decoding apparatus refers to a decision flag and determines if the copy of a past reference frame is used for an applicable macroblock or the difference data are decoded. And if the decision flag is of a value that indicates the permission of the copy, an image is copied from the past reference frame, whereas if the decision flag is of a value indicating that the copy is not permitted and the difference data are to be decoded, the difference data are decoded so as to be added to the reference frame. As a result, the increase in code amount can be suppressed and at the same time the above-described problems can be avoided and the quality of compressed image can be enhanced.

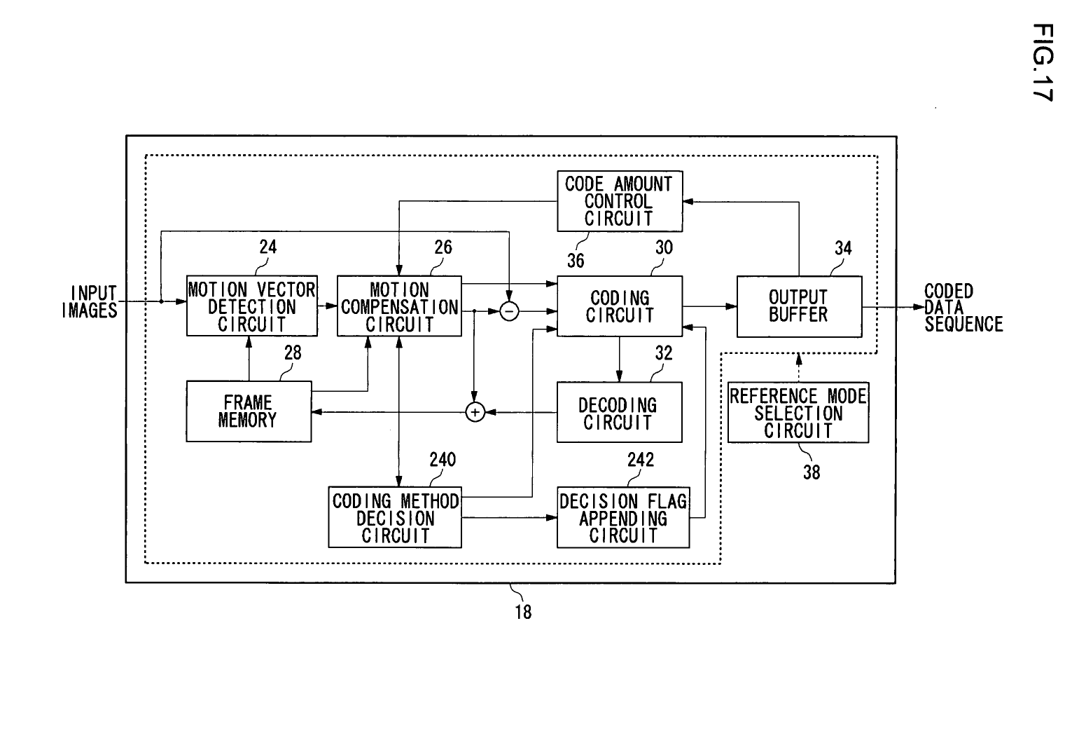

FIG. 17 shows a structure of an image coding apparatus 18 according to the present embodiment. The structure of the image coding apparatus 18 according to the present embodiment is provided with a coding method decision circuit 240 and a decision flag appending circuit, in addition to the structure of the image coding apparatus 18 according to the first embodiment. Other components and operations are the same as those of the first embodiment. In what is to follow, a description will be given centering around points different from the first embodiment.

When it codes a macroblock of B-VOP that refers to the macroblock, coded using a “not_coded” flag, in a backward direction, the coding method decision circuit 240 determines whether the applicable macroblock may be processed as a copy of the corresponding macroblock in a past reference frame or not. The coding method decision circuit 240 acquires difference data, between a current frame and a reference frame, outputted from a motion compensation circuit 26. And if the amount of the difference data is smaller than a prescribed threshold value, the coding method decision circuit 240 permits the use of the copy of the past reference frame, whereas if larger, it has the difference data coded by the coding circuit 30. The coding method decision circuit 2 communicates the decision result to the decision flag appending circuit 242.

The coding method decision circuit 240 may determine whether the copy of the past reference frame is to be used or not, in accordance with a code amount required for the coded data sequence, the image quality of a decoded image, the application of a decoded image, the capacity of a medium that records the images, the condition of a communication path through which the images are transmitted and received, and the like. Such criteria may be supplied to the coding method decision circuit 240 as control information from the equipment equipped with the image coding apparatus 18. For example, when the priority is given to the image quality of decoded images, the difference data may be coded and inserted into a coded data sequence even if the difference data are small, so that the use of the copy of the past reference frame may be inhibited. In the case where an image is recorded in a mobile phone or the like and then transmitted, the code amount may be suppressed in a manner that the threshold value for the decision is set to a larger value and thus the least amount of difference data are contained.

The decision flag appending circuit 242 acquires a result by the coding method decision circuit 240, and appends a decision flag to a prescribed position of a coded data stream. The decision flag may be appended for each macroblock of B-VOP, each B-VOP, each macroblock of a frame that B-VOP refers to in a backward direction or each frame that B-VOP refers to in a backward direction. Also, the decision flag may be appended to a macroblock, coded using a “not_coded” flag, of a frame that B-VOP refers in a backward direction or a frame, which contains a macroblock coded using a “not_coded” flag, among frames that B-VOP refers to in a backward direction. Also, the decision flag may be appended to a sequence header of a coded data stream.

When it appends the decision flag for each B-VOP, the decision flag appending circuit 242 may determine the decision flag to be appended, based on the number of macroblocks processed as copies of past reference frames in the macroblocks contained in B-VOP. For example, if the number of macroblocks processed as copies account for more than the half, a value with which to permit the use of a copy of a past reference frame will be appended as the decision flag, so that all of macroblocks contained in said B-VOP are processed as copies of the past reference frames. Similarly, when it appends a decision flag to a sequence header, the decision flag appending circuit 242 may determine a decision flag, in accordance with the number of macroblocks or frames processed as copies of the past reference frames.

The decision flag appending circuit 242 may determine the position to which the decision flag is appended, in accordance with a code amount required for the coded data sequence, the image quality of a decoded image, the application of a decoded image, the capacity of a medium that records the images, the condition of a communication path through which the images are transmitted and received, and the like. Such criteria may be supplied to the coding method decision circuit 240 as control information from the equipment equipped with the image coding apparatus 18. For example, when the priority is given to the image quality of decoded images, the decision flag may be appended for each macroblock. Also, if the code amount is to be restricted, the decision flag may be appended for each frame or each sequence header.

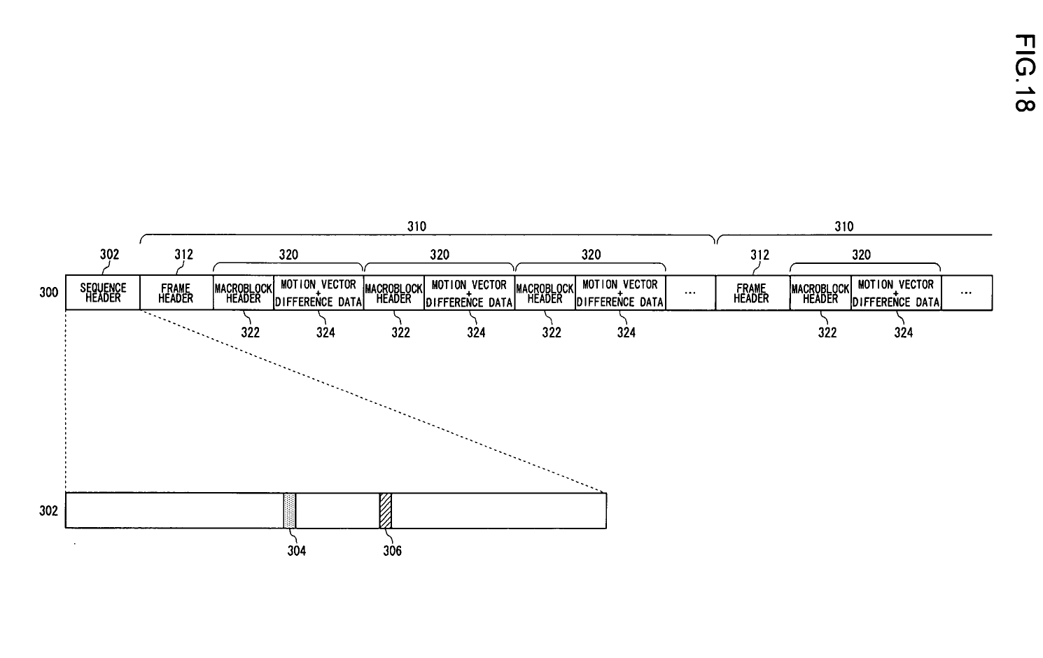

FIGS. 18 to 21 each show a data structure of coded data sequence generated by the image coding apparatus 18 according to the present embodiment. The coded data sequence contains a decision flag, at a prescribed position thereof, indicating whether a first block coded by the inter-frame bidirectional predictive mode is to be a copy of a prescribed block of a second frame that the first frame refers to in a forward direction or difference data are decoded between a block of the first frame and the prescribed block of the second frame.

FIG. 18 shows an example where a decision flag is appended to a sequence header. A coded data sequence 300 corresponds to “Video Object Layer” in MPEG-4, and contains a sequence header 302 and a plurality of frames 310. A frame 310 corresponds to “Video Object Plane” in MEPG-4, and contains a frame header 312 and a plurality of macroblocks 320. A macroblock 320 corresponds to “Macroblock” in MPEG-4, and contains a macroblock header 322 and coded data 324 in which a motion vector and difference data are coded. In the example of FIG. 18, data 304 representing the type of profile of the coded data sequence 300 are stored at a prescribed position of the sequence header 302. If the profile of the coded data sequence 300 is a profile in which B-VOP can be used and B-VOP is contained in the coded data sequence 300, a decision flag 306 will be appended at a prescribed position of the sequence header 302.

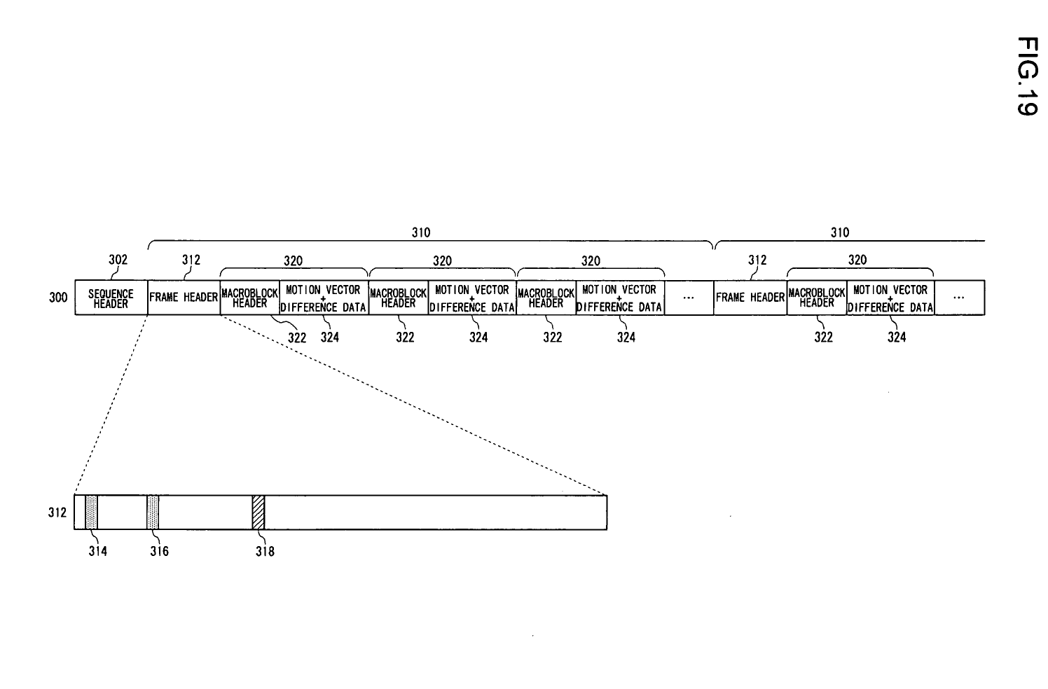

FIG. 19 shows an example where a decision flag is appended to a frame header. In the example of FIG. 19, data 314 indicating the kind of VOP and flag information 316 indicating whether this VOP has difference data or not are stored in a frame header 312 of a frame of B-VOP or a frame header 312 of a frame that B-VOP refers to in a backward direction. If it has difference data, a decision flag 318 will be appended at a prescribed position of the frame header.

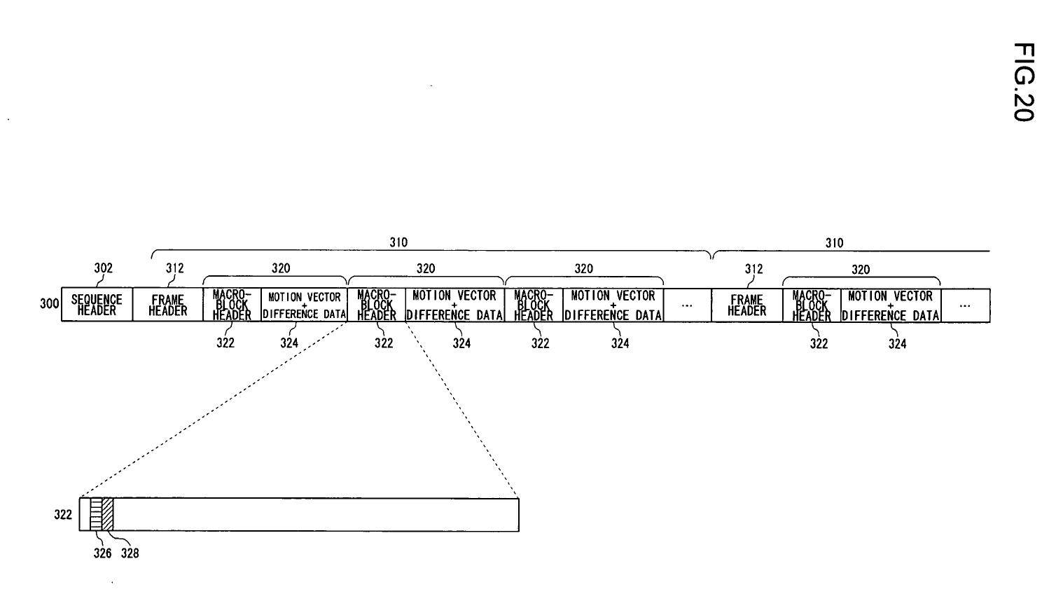

FIG. 20 shows an example where a decision flag is appended to a macroblock header that B-VOP refers to in a backward direction. In the example of FIG. 20, a “not_coded” flag 326 is stored in a macroblock header 322 of P-VOP which is, for example, a frame that B-VOP refers to in a backward direction. If the macroblock is “not_coded”, a decision flag 328 will be appended at a prescribed position of the macroblock header 322, for example, a position immediately following the “not_coded” flag 326.

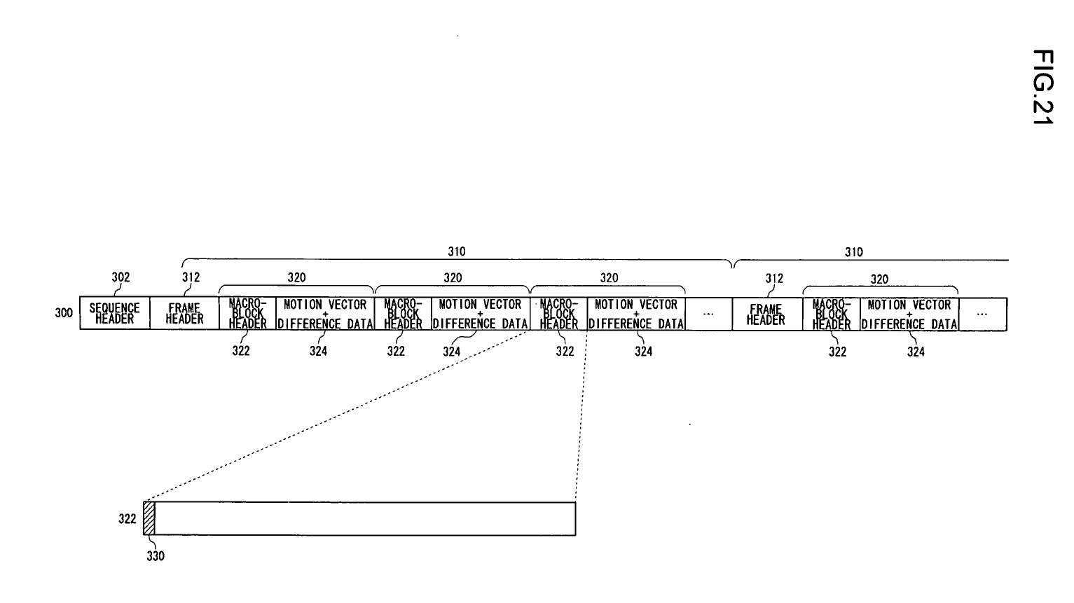

FIG. 21 shows an example where a decision flag is appended to a macroblock header of B-VOP. In the example of FIG. 21, if the macroblock corresponding to a frame that B-VOP refers to in a backward direction is “not_coded”, a decision flag 330 will be appended at a prescribed position of the macroblock header 322, for example, the leading part thereof.

With the structure as above, even if the macroblock of a frame that B-VOP refers to in a posterior direction is almost the same as the macroblock corresponding to a frame that it refers to in a forward direction and the coding is performed using the “not_coded” flag, a macroblock corresponding to B-VOP can be provided with difference data relative to a reference image. Thereby, the loss of image can be prevented and the image quality of decoded image can be enhanced. If a difference between a macroblock of B-VOP and a past reference frame is small, the coding is done using the “not_coded” flag, so that the code amount can be suppressed.

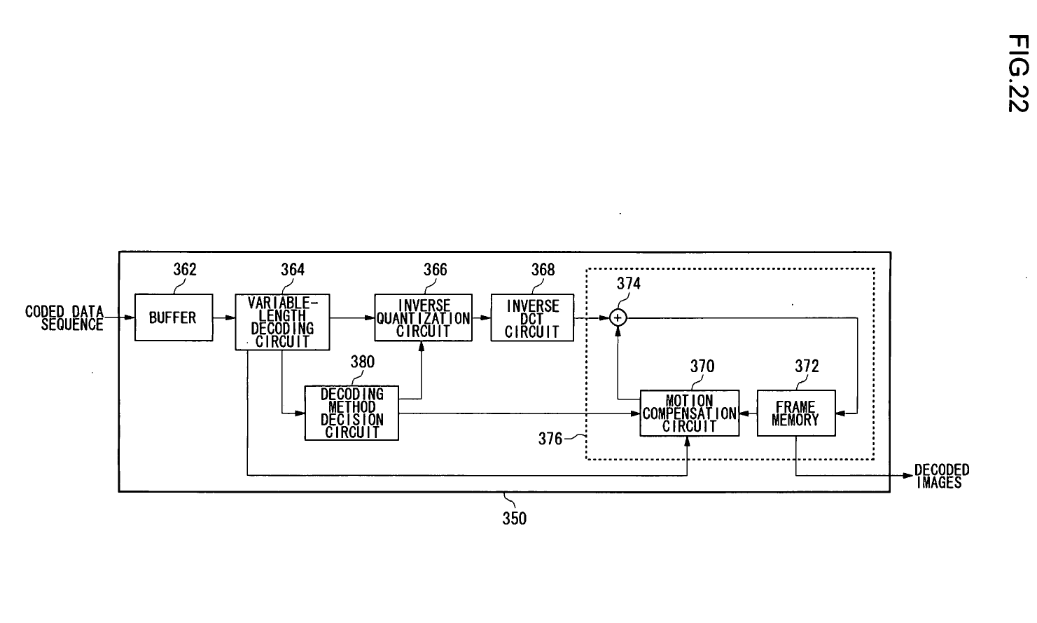

FIG. 22 shows a general structure of an image decoding apparatus 350 according to an embodiment of the present invention. This image decoding apparatus 350 includes a buffer 362 which stores coded data sequences which have been compressed and coded in the MPEG-4 scheme, a variable-length decoding circuit 364 which receives the data from the buffer 362 and decodes variable-length codes such as motion vectors, an inverse quantization circuit 366 which subjects the conversion coefficients obtained from the variable-length decoding circuit 364 to the inverse quantization so as to be converted to DCT coefficients, an inverse DCT circuit 368 which restores a sequence of DCT coefficients generated by the inverse quantization circuit 366 to the DCT coefficients in units of 8×8 block and then subjects them to the inverse DCT so as to output difference data, and a motion compensation unit 376 which decodes images from reference image data, based on a reference address and difference data based on a motion vector and stores them in an internal memory and, thereafter, generates the output image data.

The motion compensation unit 376 includes a frame memory 372 which stores image data, a motion compensation circuit 370 which reads out reference image data from the frame memory 372, based on motion vectors, an adder circuit 374 which adds up the reference image data and the difference data and then outputs decoded image data to the frame memory 372. Output image data are outputted from the frame memory 372.

The coding method decision circuit 380 acquires a decision flag placed at a prescribed position of a coded data stream, and decides on a method for decoding B-VOP. The position of a decision flag may be a header of a macroblock, a frame header or a sequence header or any other arbitrary position as long as it is commonly recognized by both the image coding apparatus 18 and the image decoding apparatus 350. In the case when a macroblock that B-VOP refers to in a posterior direction was being coded by a “not_coded” flag, if a macroblock of B-VOP is also of a value indicating that the macroblock of B-VOP be also processed as a copy of the past reference frame, the decoding method decision circuit 380 conveys to the motion compensation circuit 370 that the copying be done. The motion compensation circuit 370 reads out the macroblock of the past reference frame from the frame memory 372 and then copies it to the macroblock of B-VOP. If the decision flag has a value indicating that the copy is not permitted and the difference data shall be decoded, the decoding method decision circuit 380 has the inverse quantization circuit 366 and the inverse DCT circuit 368 decode the difference data and adds the decoded difference data to the macroblock of the past reference frame so as to obtain the macroblock of B-VOP. As a result, the coded data sequence coded by the image coding apparatus 18 according to the present embodiment can be suitably decoded.

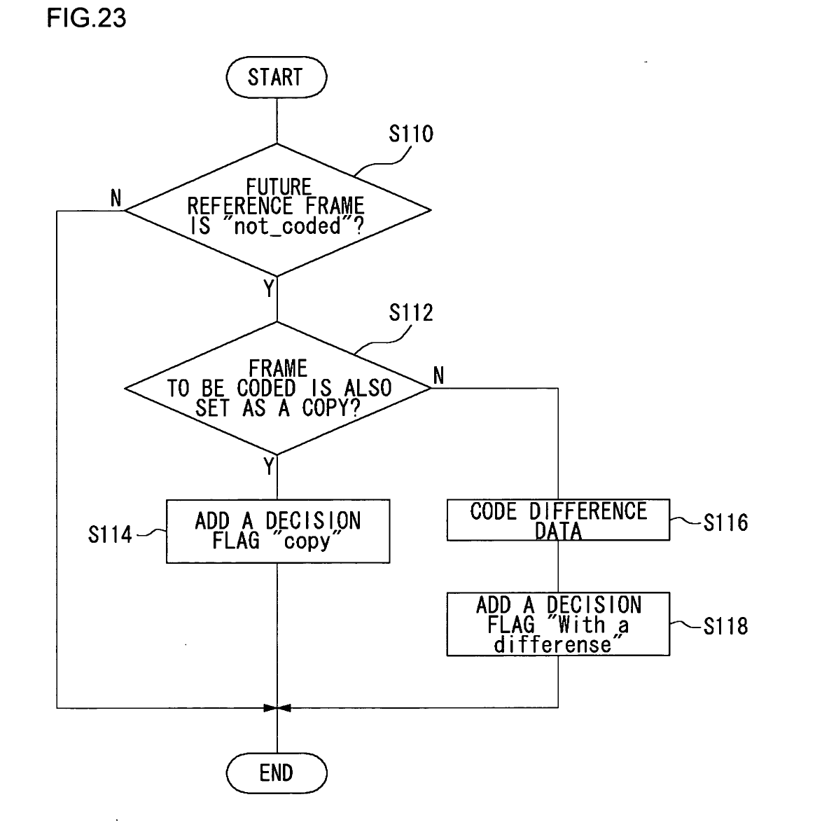

FIG. 23 is a flowchart showing a procedure for an image coding method according to the present embodiment. FIG. 23 shows a procedure in which the image coding apparatus 18 performs the coding on frames to be coded, in an inter-frame bidirectional predictive mode. When B-VOP is to be coded, the coding method decision circuit 240 first checks if a macroblock to be coded refers to a macroblock coded, using a “not_coded” flag, in a future direction or not (S110). If the macroblock of the future reference frame is not “not_coded” (N of S110), a normal coding processing is carried out. If the macroblock of the future reference frame is “not_coded” (Y of S110), the coding method decision circuit 240 determines whether the macroblock to be coded shall be regarded also as a copy of a past reference frame (S112). If the coding method decision circuit 240 determines that it is regarded as a copy (Y of S112), the decision flag appending circuit 242 will append a decision flag indicating that a copy of the past reference frame is inserted, to a prescribed position of the coded data sequence (S114). If the coding method decision circuit 240 determines that difference data instead of the copy are provided (S116), the decision flag appending circuit 242 will append a decision flag indicating that the different data are contained (S118).

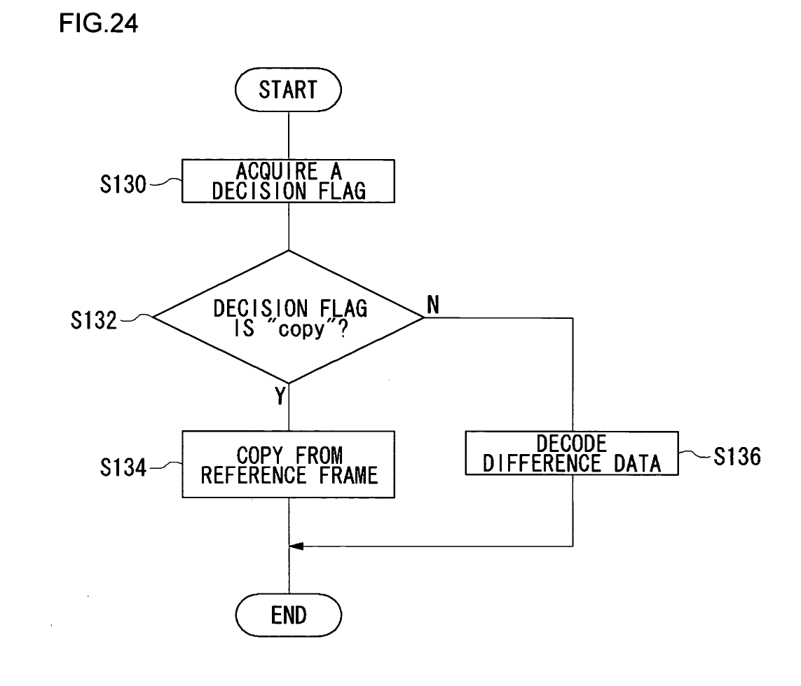

FIG. 24 is a flowchart showing a procedure for an image decoding method according to the present embodiment. FIG. 24 shows a procedure in which the image decoding apparatus 350 decodes frames coded in an inter-frame bidirectional predictive mode. First, the decoding method decision circuit 380 acquires a decision flag appended to a prescribed position of the coded data sequence (S130), and verifies the type of the decision flag (S132). If the decision flag is of a value indicating that when a macroblock of a future reference frame of B-VOP is “not_coded”, a macroblock of BOP is also processed as a copy of a macroblock of a past reference frame (Y of S132), the decoding method decision circuit 380 instructs other circuits that the copy of a macroblock of the past reference frame be inserted to a macroblock of B-VOP (S134). If the decision flag is of a value indicating that the macroblock of B-VOP contains difference data (N of S132), the decoding method decision circuit 380 instructs other circuits that the difference data be decoded to generate an image of the macroblock of B-VOP (S136).

The present invention has been described based on the embodiments. These embodiments are merely exemplary, and it is understood by those skilled in the art that various modifications to the combination of each component and process thereof are possible and that such modifications are also within the scope of the present invention.

### INDUSTRIAL APPLICABILITY

The present invention can be used in an image coding apparatus which codes moving images.

1. (canceled)

2. An image coding apparatus, comprising:
a coding circuit which codes an image signal to be coded, by using intra-frame coding scheme and/or inter-frame coding scheme; and
a reference mode selection circuit which sets selectively either a reference mode that uses a bidirectional coding in which a past frame and a future frame are referred to or a reference mode that does not use the bidirectional coding, as the inter-frame coding scheme, according to an coding execution environment in said apparatus,
wherein said reference mode selection circuit sets the reference mode, according to whether the reference mode that uses the bidirectional coding or the reference mode that does not use the bidirectional coding is more suitable for the coding execution environment in said apparatus, with reference to a level of compression ratio.

3. An image coding apparatus, comprising:
a coding circuit which codes an image signal to be coded, by using intra-frame coding scheme and/or inter-frame coding scheme; and
a reference mode selection circuit which sets selectively either a reference mode that uses a bidirectional coding in which a past frame and a future frame are referred to or a reference mode that does not use the bidirectional coding, as the inter-frame coding scheme, according to an coding execution environment in said apparatus,
wherein said reference mode selection circuit sets the reference mode, according to whether the reference mode that uses the bidirectional coding or the reference mode that does not use the bidirectional coding is more suitable for the coding execution environment in said apparatus, with reference to a level of load caused by a coding processing.

4. An image coding apparatus, comprising:
a coding circuit which codes an image signal to be coded, by using intra-frame coding scheme and/or inter-frame coding scheme; and
a reference mode selection circuit which sets selectively either a reference mode that uses a bidirectional coding in which a past frame and a future frame are referred to or a reference mode that does not use the bidirectional coding, as the inter-frame coding scheme, according to an coding execution environment in said apparatus,
wherein said reference mode selection circuit sets the reference mode, according to whether the reference mode that uses the bidirectional coding or the reference mode that does not use the bidirectional coding is more suitable for the coding execution environment in said apparatus, with reference to a level of advantage on specifications in a case when the bidirectional coding is performed on the image signal.

5. An image coding apparatus according to claim 2, wherein as the coding scheme said coding circuit codes the image signal by using a scheme complying with MPEG,
in the reference mode that uses a bidirectional coding, the coding is performed using I pictures, P pictures and B pictures, and
in the reference mode that does not use the bidirectional coding, I pictures and P pictures are used.

6. An image pickup apparatus, comprising:
an image input unit which takes an image of an object and acquires an image signal;
an image coding apparatus according to claim 2, which codes the image signal; and
a data storage unit which stores coded data generated by the coding.

7-28. (canceled)
